(19) United States
(12) Patent Application Publication
(10) Pub. No.: US 2026/0180663 A1
(43) Pub. Date: Jun. 25, 2026

(54) BEAM FAILURE RECOVERY FOR DEVICES MONITORING LOW-POWER SIGNALS

(71) Applicant: InterDigital Patent Holdings, Inc., Wilmington, DE (US)

(72) Inventors: Prasanna Herath, Laval, CA (US); Young Woo Kwak, Woodbury, NY (US); Nazli Khan Beigi, Longueuil, CA (US); Moon IL Lee, Melville, NY (US); Samuli Turtinen, Li (FI); Jongwoo Hong, New York, NY (US); Virgile Garcia, Antibes (FR)

(73) Assignee: InterDigital Patent Holdings, Inc., Wilmington, DE (US)

(21) Appl. No.: 18/990,384

(22) Filed: Dec. 20, 2024

(51) Int. Cl. H04B 7/06; H04W 74/0833; H04W 76/28; H04W 76/38

(52) U.S. Cl. CPC H04B 7/06964; H04W 74/0833; H04W 76/28; H04W 76/38

(57) ABSTRACT

Methods, systems, and devices for detecting beam failures and/or performing a beam failure recovery are provided for various types of devices that can operate in one or more low power modes. A wireless transmit/receive unit (WTRU) may include a low power radio (LR) and a main radio (MR). The WTRU may operate in a low power (LP) mode in which the MR is inactive (e.g., in a sleep mode). The WTRU may monitor one or more LP signals while operating in the low power mode. The WTRU may detect one or more potential MR beam failures based on one or more LR measurements using the LR. Upon detecting a potential MR beam failure, the WTRU may evaluate the detected potential MR beam failure. If the potential MR beam failure is determined to be an MR beam failure, the WTRU may perform the beam failure recovery using the MR.

### BACKGROUND

In fifth generation (5G) communication networks, one or more devices can operate in one or more low power modes. To facilitate operating in the low power modes, the network may provide one or more low power signals such as one or more low power synchronization signals. Typically, the devices utilize a low power radio to receive the one or more low power signals. However, in case of a beam failure, the devices use a main radio to detect the beam failure and to perform beam recovery. Switching on and utilizing the main radio consumes power, and hence, results in inefficient performance of the devices.

### SUMMARY

In various embodiments of the present disclosure, a wireless transmit/receive unit (WTRU) is provided. The WTRU comprises a memory, a low power radio (LR), a main radio (MR), a transceiver, and a processor. The transceiver is configured to receive, from a base station, first configuration information (e.g., LR beam failure detection (BFD) configuration information) indicating one or more of: one or more LR resources, an LR signal quality threshold, an LR beam failure instance (LR-BFI) counter threshold, or an LR beam failure detection (LR-BFD) timer value. The transceiver and the processor are configured to monitor a low power (LP) signal, measure an LR signal quality of the one or more LR resources, determine an LR BFI when the LR signal quality is less than the LR signal quality threshold, initialize an LR-BFD timer using the LR-BFD timer value, increment an LR-BFI counter upon detecting the LR-BFI, and determine a potential MR beam failure when the LR-BFI counter exceeds the LR-BFI counter threshold and the LR-BFD timer has not expired.

In an embodiment, the transceiver and the processor are further configured to receive, from the base station, second configuration information (e.g., first MR-BFD configuration information) indicating one or more of: one or more MR resources, an MR signal quality threshold, an MR beam failure instance (MR-BFI) counter threshold, or an MR beam failure detection (MR-BFD) timer value, and evaluate the potential MR beam failure based on the second configuration information.

In an embodiment, evaluating the potential MR beam failure comprises: resetting the LR-BFD timer and the LR-BFI counter, activating the MR, initializing an MR-BFD timer using the MR-BFD timer value, measuring an MR signal quality of the one or more MR resources, determining an MR-BFI when the MR signal quality is less than the MR signal quality threshold, and incrementing an MR-BFI counter upon determining the MR-BFI.

In an embodiment, the transceiver and the processor are further configured to determine an MR beam failure when the MR-BFI counter exceeds the MR-BFI counter threshold within a time window.

In an embodiment, the transceiver and the processor are further configured to receive third configuration information (e.g., beam failure recovery (BFR) configuration information) indicating one or more of: one or more candidate LR beams, one or more candidate MR beams, an association between the one or more candidate LR beams and the one or more candidate MR beams, a first set of physical random-access channel (PRACH) resources, a second set of PRACH resources, an LR beam quality threshold, or an MR beam quality threshold.

In an embodiment, the transceiver and the processor are further configured to: determine that at least one LR beam from the one or more candidate LR beams meets the LR beam quality threshold, determine that at least one MR beam associated with the at least one LR beam meets the MR beam quality threshold, select the at least one LR beam and the at least one MR beam, and transmit, to the base station using the first set of PRACH resources, an indication of selecting the at least one LR beam and the at least one MR beam.

In an embodiment, the transceiver and the processor are further configured to: determine that at least one MR beam from the one or more candidate MR beams meets the MR beam quality threshold, determine that no LR beam from the one or more candidate LR beams meets the beam quality threshold, operate in a discontinuous reception (DRX) mode using the at least one MR beam, and transmit, to the base station using the second set of PRACH resources, an indication of the DRX mode using the at least one MR beam.

In an embodiment, the transceiver and the processor are further configured to: exit the LP signal monitoring when the MR-BFI counter does not exceed the MR-BFI counter threshold within a time window, and transmit an indication to the base station upon exiting the LP signal monitoring.

In an embodiment, the transceiver and the processor are further configured to: receive fourth configuration information (e.g., second MR BFD configuration information), and detect the MR beam failure based on the fourth configuration information when operating in a DRX mode.

In embodiment, the MR is inactive while monitoring the LP signal.

In various embodiments of the present disclosure, a method for use in a WTRU is provided. The method includes receiving, from a base station, first configuration information (e.g., LR-BFD configuration information) indicating one or more of: one or more LR resources, an LR signal quality threshold, an LR-BFI counter threshold, or an LR-BFD timer value. The method includes monitoring a LP signal using a low power radio receiver. The method includes measuring an LR signal quality of the one or more LR resources. The method includes determining an LR BFI when the LR signal quality is less than the LR signal quality threshold. The method includes initializing an LR-BFD timer using the LR-BFD timer value. The method includes incrementing an LR-BFI counter upon detecting the LR-BFI. The method includes determining a potential MR beam failure when the LR-BFI counter exceeds the LR-BFI counter threshold and the LR-BFD timer has not expired.

In an embodiment, the method includes receiving, from the base station, second configuration information (e.g., first MR-BFD configuration information) indicating one or more of: one or more MR resources, an MR signal quality threshold, an MR-BFI counter threshold, or an MR-BFD timer value. The method includes evaluating the potential MR beam failure based on the second configuration information.

In an embodiment, evaluating the potential MR beam failure includes: resetting the LR-BFD timer and the LR-BFI counter, activating the MR, initializing an MR-BFD timer using the MR-BFD timer value, measuring an MR signal quality of the one or more MR resources, determining an MR-BFI when the MR signal quality is less than the MR signal quality threshold, and incrementing an MR-BFI counter upon determining the MR-BFI.

In an embodiment, the method includes determining an MR beam failure when the MR-BFI counter exceeds the MR-BFI counter threshold within a time window.

In an embodiment, the method includes receiving third configuration information (e.g., BFR configuration information) indicating one or more of: one or more candidate LR beams, one or more candidate MR beams, an association between the one or more candidate LR beams and the one or more candidate MR beams, a first set of PRACH resources, a second set of PRACH resources, an LR beam quality threshold, or an MR beam quality threshold.

In an embodiment, the method includes determining that at least one LR beam from the one or more candidate LR beams meets the LR beam quality threshold. The method includes determining that at least one MR beam associated with the at least one LR beam meets the MR beam quality threshold. The method includes selecting the at least one LR beam and the at least one MR beam. The method includes transmitting, to the base station using the first set of PRACH resources, an indication of selecting the at least one LR beam and the at least one MR beam.

In an embodiment, the method includes determining that at least one MR beam from the one or more candidate MR beams meets the MR beam quality threshold. The method includes determining that no LR beam from the one or more candidate LR beams meets the beam quality threshold. The method includes operating in a DRX mode using the at least one MR beam. The method includes transmitting, to the base station using the second set of PRACH resources, an indication of the DRX mode using the at least one MR beam.

In an embodiment, the method includes exiting the LP signal monitoring when the MR-BFI counter does not exceed the MR-BFI counter threshold within a time window. The method includes transmitting an indication to the base station upon exiting the LP signal monitoring.

In an embodiment, the method includes receiving fourth configuration information (e.g., second MR BFD configuration information). The method includes evaluating the MR beam failure based on the fourth configuration information when operating in a DRX mode.

In an embodiment, a main radio receiver is inactive while monitoring the LP signal.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example simplified receiver architecture of a WTRU utilizing low-power wake-up receiver according to one or more embodiments;

FIG. 3 illustrates an example schematic representation of potential main radio beam failure determination based on the one or more low power radio measurements and evaluating the determined potential main radio beam failure based on one or more main radio measurements according to one or more embodiments; and

FIGS. 4A-4B are a flowchart illustrating a method for beam failure recovery for use in one or more devices monitoring one or more low-power signals according to one or more embodiments.

### DETAILED DESCRIPTION

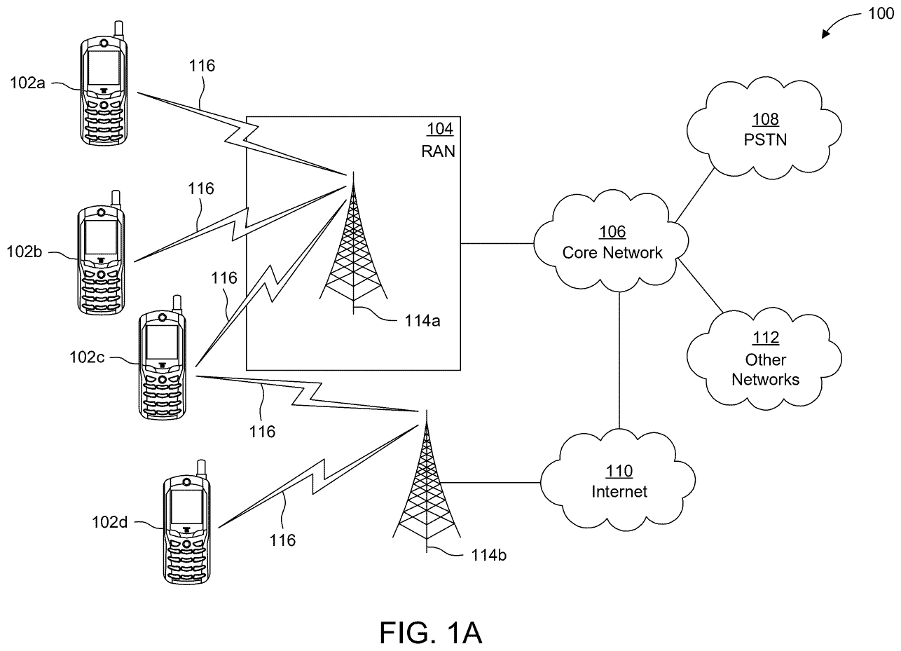

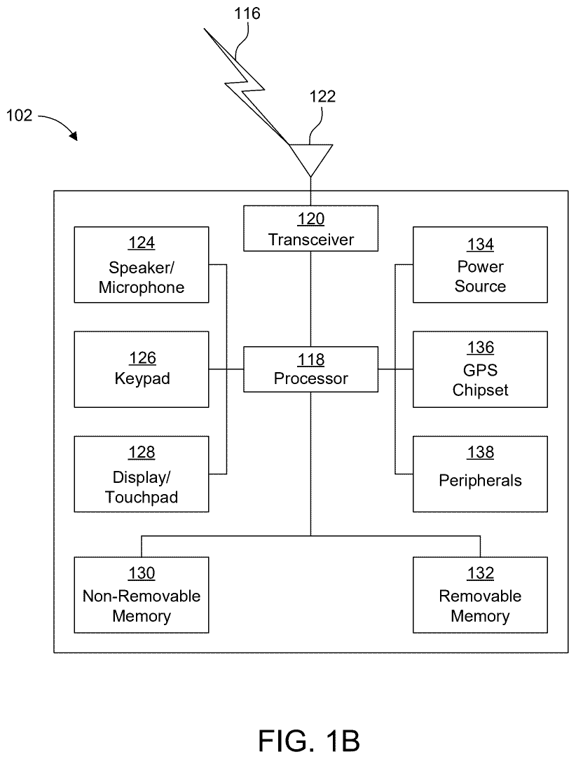

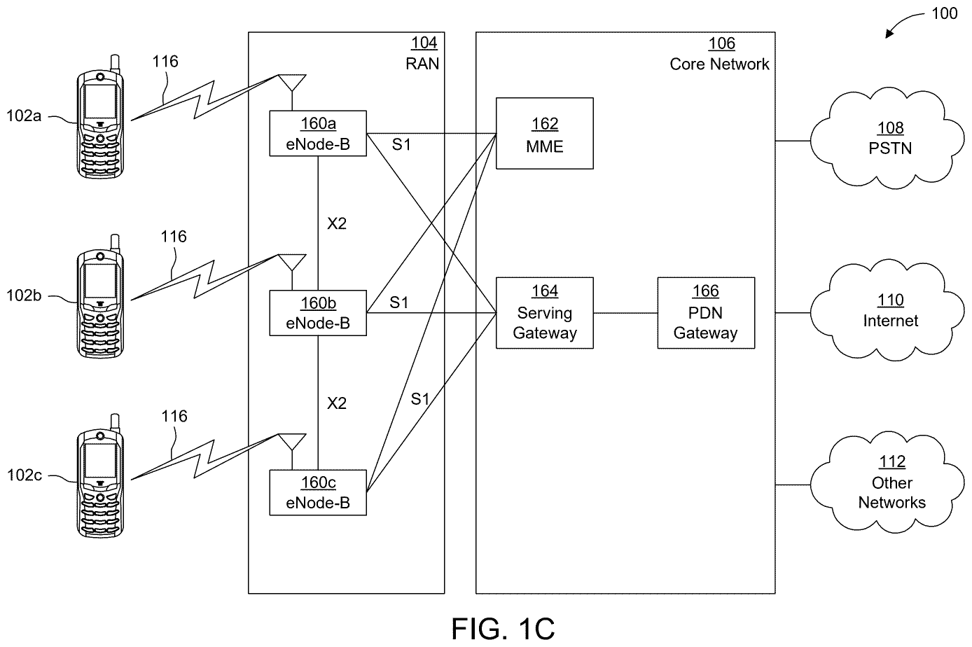

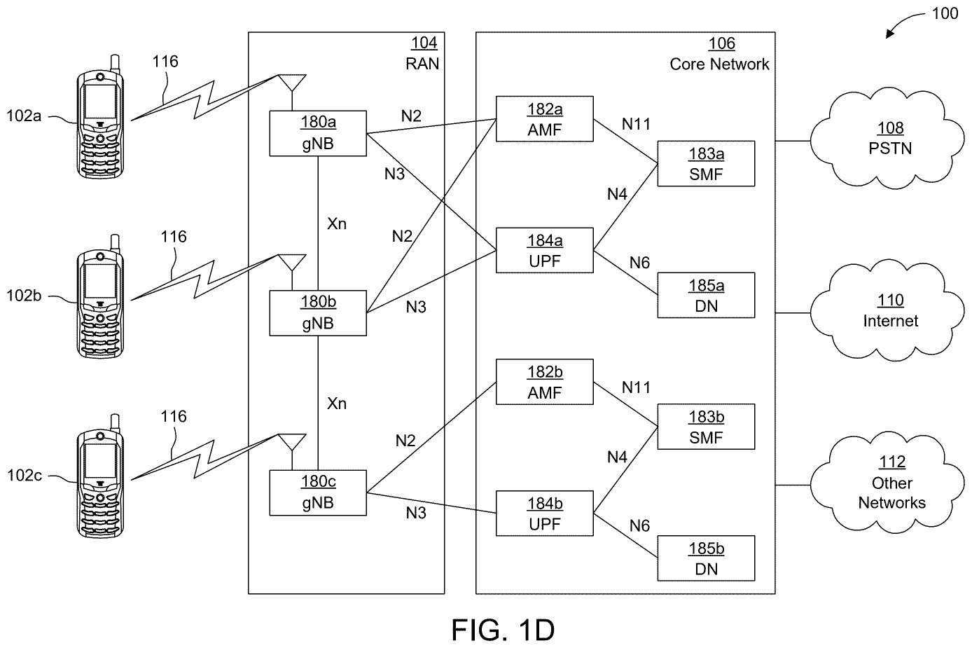

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may monitor and receive a wake-up signal (WUS) and/or one or more signals (e.g., a low-power synchronization signal (LP-SS)) which assist reception of the WUS via a first radio (e.g., a low-power radio and/or ultra-low power radio). The WUS may be referred to as a low-power WUS (LP-WUS). The first radio may be referred to as a low-power radio (LR) and/or a low power wake-up radio (LP-WUR). A received WUS (e.g., an LP-WUS), for example via the LR, may trigger wake-up and/or use of a second radio of the WTRU (e.g., a main radio (MR) of the WTRU) for data and/or control signal transmission and/or reception. This has a potential to reduce a power consumption of the WTRU.

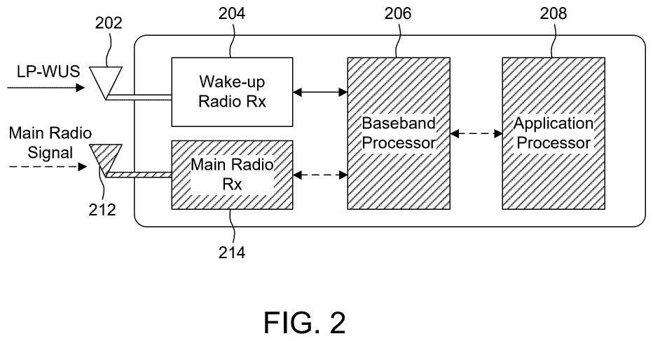

Referring now to FIG. 2, an example simplified receiver architecture of a WTRU utilizing a low-power wake-up receiver is shown according to one or more embodiments. The WTRU may include a first antenna 202, a wake-up radio 204, a baseband processor 206, an application processor 208, a second antenna 212, and a main radio 214. The first antenna 202 may be a low power signal antenna and the second antenna 212 may be a main antenna. In an embodiment, for example, the first antenna and the second antenna 212 may be implemented by way of a single antenna. The single antenna may operate in multiple modes, for instance, a low power mode to receive the LP-WUS and an operational mode to receive the MR signal. In an example, the wake-up radio 204 and the main radio 214 may be implemented by way of a single radio which may operate in different modes.

Fifth generation (5G) communication systems may include a PCell beam failure detection and recovery procedure. In a 5G new radio (NR) beam failure recovery (BFR) procedure, a WTRU monitors a set of periodic reference signals (RSs), for example synchronization signal block (SSB) and/or channel state information-reference signal (CSI-RS) etc., associated with one or more beams used for physical downlink control channel (PDCCH) transmission. For each bandwidth part (BWP) of a serving cell, a WTRU may be provided a set of periodic CSI-RS resource configuration indexes and/or a set of SSB indexes (set q̅₀) by failure detection resources in an RRC configuration. If no RSs are provided for the purpose of the BFD, the WTRU may perform beam monitoring based on a reference signal (RS) set indicated by an activate transmission configuration indicator (TCI) state for the PDCCH reception. If there are two RSs in the TCI state, set q̅₀ may include an RS index with a quasi colocation (QCL) type-D configuration for one or more corresponding TCI states. When a measured beam quality of all RSs in the set q̅₀ becomes lower than a threshold configured number of times consecutively (e.g. beamFailureInstanceMaxCount reaches a configured threshold value subject to beamFailureDetectionTimer), the WTRU may declare a beam failure (BF). Upon declaring a BF, the WTRU may initiate a BFR procedure in which the WTRU may identify a new beam within a preconfigured duration (e.g., determined based on a beamFailureRecoveryTimer). The new beam may be selected from a set of RSs (e.g., SSB and/or CSI-RS) q̅₁ configured by candidateBeamRSList in the RRC configuration. After finding the new beam, the WTRU may transmit a beam recovery request and a BF indication via a dedicated physical random access response channel (PRACH) preamble to the gNB. To this end, the gNB may determine one or more PRACH resources based on configured association between a set of RSs in q̅₁ and a set of PRACH resources configured by BFR-SSB-Resource and/or BFR-CSIRS-Resource in the RRC configuration. After receiving the PRACH preamble, the WTRU may receive a confirmation for the new beam from the gNB. For example, the WTRU may be provided a search space (SS) by recoverySearchSpaceId in the RRC configuration for monitoring for and/or receiving a confirmation for the new beam in the PDCCH. If a response is successfully received by the WTRU, the beam recovery procedure may be successful, and a new beam pair link may be established. Otherwise, the WTRU may perform one or more additional beam recovery requests by ramping up a power of the PRACH preamble transmission. If this still fails, the WTRU may initiate a contention-based RACH procedure, which possibly includes cell re-selection.

In an example, a conventional WTRU detects the BF by measuring a beam quality (e.g., the RSRPs) of one or more periodic failure detection (BFD) RSs. In an example, for the LP signal monitoring WTRUs, to measure the one or more BFD RSs via the MR, the conventional WTRU may wake-up and/or activate the MR. periodically. In that, waking-up and/or activating the MR periodically for measuring BFD RSs increases power consumption of the conventional WTRU.

In various embodiments of the present disclosure, a beam failure recovery procedure and a LP-WUS monitoring procedure is provided.

In an embodiment, the WTRU may determine one or more potential beam failures associated with the MR radio link based on one or more beam measurements associated with the LR radio link. Upon detecting a beam failure, the WTRU may select a new beam for the MR radio link and the LR radio link together considering association between one or more LR beams and one or more MR beams, and a signal quality. The WTRU may receive a confirmation for the new beam selections and/or beam the pair selections via the LP signal. The WTRU may postpone the beam failure recovery of the MR radio link and operate based on the LP signal monitoring.

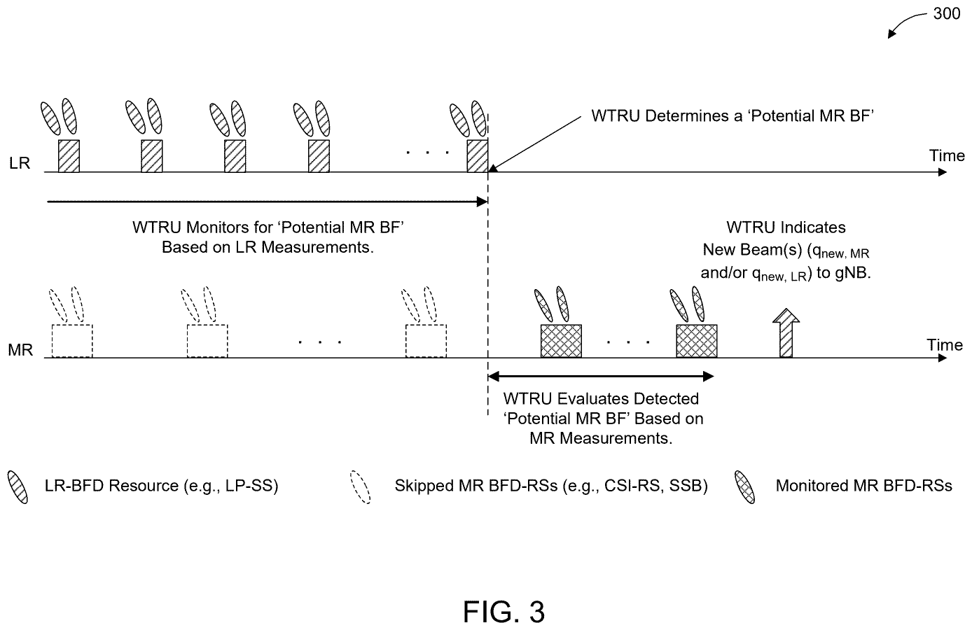

Referring now to FIG. 3, an example schematic representation 300 of the potential MR BF determination based on the one or more LR measurements and evaluating the determined potential MR BF based on the one or more MR measurements is shown according to one or more embodiments.

In an embodiment, the WTRU detects the one or more potential MR beam failures (i.e. the potential MR BFs) based on the one or more LR measurements. The WTRU that detects the potential MR BF, measures one or more MR beam failure detections reference signals (MR BFD-RSs) to evaluate the detected potential MR BF. If the potential MR BF is determined to be an MR BF, the WTRU may perform the BFR via the MR and/or the LR.

The WTRU may receive one or more of the following configurations (e.g. configuration information) and/or indications from the gNB: a BFD configuration (LR-BFD configuration) associated with the LR, one or more BFD configurations (e.g., first and second MR-BFD configurations) associated with the MR, and/or a BFR configuration etc. The WTRU may receive the one or more LR beams and the one or more configurations (e.g. the configuration information) and/or indications for starting to monitor for the one or more LP signals (e.g., the LP-WUS).

The BFD configuration (LR-BFD configuration) associated with the LR may include one or more of: the one or more LR resources (e.g., LP-SSs) for the BFD (q_{0, LR}), an LR signal quality threshold for the q_{0, LR}, an LR beam failure instance (BFI) counter and associated threshold, and/or a timer value (e.g., LR-BFD timer value) associated with the LR-BFI counter etc.

The one or more BFD configurations (e.g., the first and second MR-BFD configurations and/or the first and second MR-BFD configuration information) associated with the MR may include one or more of: a set of MR RSs for BFD (q_{0, MR}), one or more MR resources in the q_{0, MR}, an MR signal quality threshold for the q_{0, MR}, an MR-BFI counter and associated threshold, and/or a timer value (e.g., MR-BFD timer value) associated with the MR-BFI counter etc.

In an example, the first and second MR-BFD configurations may share one or more configurations and/or parameters except the MR-BFI counters and the respective thresholds (e.g., the first MR-BFD configuration information is associated with the first MR-BFI counter and the first MR-BFI counter threshold, and the second MR-BFD configuration information is associated with the second MR-BFI counter and the second MR-BFI counter threshold (e.g., the second MR-BFI counter threshold may be greater than the first MR-BFI counter threshold) respectively).

The BFR configuration may include one or more of: a set of candidate beams for LR (q_{1, LR}) and MR (q_{1, MR}), an association between the q_{1, MR} and the q_{1, LR} (e.g., one or more beams in the q_{1, MR} associated with each beam in the q_{1, LR}), the first and second beam quality thresholds, the first and second sets of the PRACHs resources associated with (e.g., each) beam in the q_{1, MR}, a search space (BFR SS), and/or a sequence associated with LP-WUS etc.

The WTRU starts monitoring for the LP-WUS based on the configured LR beam.

The WTRU monitors for the potential MR BF based on the signal quality (e.g., RSRP) measurements on the q_{0, LR} via the LR. For example, if the LR signal quality (e.g., the RSRP) of one or more (e.g., all) beams in the q_{0,LR} is less than the LR signal quality threshold for the q_{0, LR}, the WTRU determines an LR BFI. If the LR-BFD timer is not running (e.g., expires), the WTRU starts or restarts the LR-BFI counter (set to 0), increases the LR-BFI counter by 1, and restarts the LR-BFD timer. If the LR-BFD timer is running, the WTRU increases the LR-BFI counter by 1, and restarts LR-BFD timer.

If the LR-BFI counter exceeds or equals the LR-BFI counter threshold, the WTRU determines the potential MR BF.

The WTRU evaluates the determined potential MR BF based on the MR measurements and the first MR-BFD configuration.

The WTRU (e.g., periodically) measures the MR signal quality (e.g., the RSRP) of the one or more MR resources in the q_{0,MR}. If the MR signal quality of one or more (e.g., all) beams in the q_{0,MR} is less than the MR signal quality threshold for the one or more MR resources in the q_{0, MR}, the WTRU determines the MR BFI. If the MR-BFD timer is not running, the WTRU starts or restarts the first MR-BFI counter (set to zero), increases the MR-BFI counter by 1, and restarts the MR-BFD timer. If the MR-BFD timer is running, the WTRU increases the first MR-BFI counter by 1, and restarts the LR-BFD timer.

If the first MR-BFI counter exceeds or equals configured threshold within a time window (e.g., a time window from starting to monitor the q_{0,MR}), the WTRU determines the potential MR BF is the MR BF.

If the WTRU determines the potential MR BF is the MR BF, the WTRU measures the signal quality of the q_{1,MR} and the q_{1, LR}. The WTRU selects one or more new beams for the MR (q_{new, MR}) and/or the LR (q_{new, LR}) based on the measurements. The WTRU indicates the one or more selected new beams to the gNB and receives a confirmation for the one or more selected new beams from the gNB via the LP-WUS and/or a DCI received via a BFR SS etc.

If at least one beam pair (e.g. at least one LR beam and at least one MR beam) meets the one or more quality thresholds (e.g. a quality of a beam among the q_{1, MR} is greater than or equal to a first beam quality threshold, and a quality of a beam in the q_{1, LR} associated with the selected beam among the q_{1, MR} is greater than or equal to a second beam quality threshold), the WTRU selects a (e.g., best) new beam pair (the q_{new, MR} and the q_{new, LR}).

The WTRU transmits a PRACH resource among the first set of PRACH resources associated with the q_{new, MR}. The WTRU receives a confirmation from the gNB for the selected new beam pair via the LP-WUS (e.g., the LP-WUS associated with a preconfigured sequence). The WTRU continues monitoring the LP-WUS based on the determined new LR beam (the q_{new, MR}).

If none of the candidate beam pairs meets respective thresholds, but quality of at least one beam in the q_{1, MR} is greater than or equal to the first beam quality threshold, the WTRU selects a (e.g., best) beam among the q_{1, MR} meeting the first beam quality threshold as the q_{new, MR}.

The WTRU transmits a PRACH resource among the second set of PRACH resources which associates with the q_{new, MR}. The WTRU receives the confirmation for the q_{new, MR} via the BFR SS. The WTRU operates based on a DRX configuration with the q_{new, MR}, and performs the BFD for the MR based on the second MR-BFD configuration.

If the WTRU determines quality of all beams in the q_{1, MR} is less than the first threshold, the WTRU performs the initial access.

If the WTRU determines that the potential MR BF is not an MR BF, the WTRU determines an LR BF. The WTRU exits the LP signal monitoring (e.g., the WTRU operates based on the DRX configuration) and transmits an indication (e.g., via a PUCCH) to the gNB. Upon exiting the LP signal monitoring, the WTRU performs the BFD for the MR based on the second MR-BFD configuration.

In an example, a process for the detection of the one or more MR beam failures is provided. The process reduces power consumption of the WTRU since the beam failure monitoring can be based on the one or more LR measurements while the MR is in a sleep state. In an example, the process facilitates fast detection of the beam failures compared to first detecting the LR BFs and subsequently monitoring for the MR BFs based on conventional BFD procedures.

Hereafter, operating the WTRU based on one or more indications and/or channels, and/or signals received via the LR may be referred to as operating the WTRU in an LP mode. While the WTRU is operating in the LP mode, the WTRU may perform one or more procedures described below.

In the LP mode, the WTRU may monitor for the one or more LP signals via the LR. The one or more LP signals may include the LP-WUS, the LP-SS, and/or any signal received via the LR.

In the LP mode, the WTRU may maintain (and/or operate) the MR in a power saving state (e.g., a deep sleep state and/or a light sleep state etc.).

In the LP mode, the WTRU may skip one or more operations performed via the MR (e.g., skip the PDCCH monitoring in the resources configured by the DRX configuration).

In the LP mode, the WTRU may wake-up the MR (e.g., for monitoring and/or receiving the PDCCHs) based on reception of the wake-up indication via the LP-WUS. Waking up the MR may move the WTRU out of the LP mode.

In the LP mode, the WTRU may (e.g., periodically) wake-up the MR and/or resume using the MR for a limited duration (e.g., a time duration preconfigured via one or more of radio resource control (RRC) signaling, medium access control-control element (MAC-CE) indication, and/or downlink control indication (DCI) indication etc.). Once the WTRU wakes up the MR and/or resumes using the MR, the WTRU may monitor for the one or more MR signals and/or channels (e.g., the CSI-RS, the SSBs, and/or the PDCCH etc.) and/or transmit one or more signals or channels (e.g., the SRS, one or more CSI reports, and/or the PRACH preamble etc.). After the limited duration, the WTRU may stop using the MR (e.g., switch the MR to the power saving state) and resume to use the LR. During the limited duration, the WTRU may monitor the one or more LP signals via the LR or skip monitoring the one or more LP signals.

Hereafter, operation in the LP mode, ‘monitoring one or more LP signals’ may be used interchangeably with ‘LP signal monitoring’, or ‘LP-WUS monitoring’ consistent with the present disclosure.

Hereafter, ‘reference signal’ and ‘beam’ may be interchangeably used to refer to a beam associated with the MR, consistent with the present disclosure.

Hereafter, ‘resource’ and ‘beam’ may be interchangeably used to refer to a beam associated with the LR, consistent with the present disclosure. In an example, the one or more LP-SS resources may be used to refer the beam associated with the LP-SS.

In an embodiment, the WTRU monitoring for the one or more LP signals (e.g., the LP-WUS and/or the LP-SS, etc.) via the LR (e.g., while the MR is in the power saving state) may detect the one or more BFs associated with the LR (hereafter referred to as an LR BF) and the one or more BFs associated with the MR (hereafter referred to as an MR BF) based on the signal quality of the one or more beams associated with the LR and/or the MR. In an example, one or more measurements associated with the LR may include the one or more measurements on the LP signal and/or channel (e.g., the LP-WUS, the LP-SS etc.). The one or more measurements associated with the MR may include the one or more measurements on the MR signal and/or the channels (e.g., the CSI-RS and/or the SSB etc.).

In an example, the WTRU may detect the one or more LR BFs, and the one or more probable MR BFs (also referred to as ‘potential MR BFs’) based on the measured signal quality of the one or more beams associated with the LR.

In an example, the WTRU may detect the one or more MR BFs or the one or more potential MR BFs based on the measured signal quality of the one or more beams associated with the LR.

In an example, the WTRU may detect the one or more MR BFs based on the measured signal quality of one or more LR beams associated with the LR.

In an example, the WTRU may detect the one or more LR BFs, and the one or more MR BFs based on measured signal quality of the one or more LR beams associated with the LR.

In an example, the WTRU may detect the one or more LR BFs based on the measured signal quality of the one or more LR beams associated with the LR.

In an example, the WTRU may detect the one or more MR BFs based on the measured signal quality of the one or more MR beams associated with the MR.

In an example, detection of the potential MR BF may trigger the WTRU to evaluate the detected potential MR BF based on the signal quality of the one or more beams associated with the WTRU. The WTRU that detects the LR BF and/or the MR BF may trigger the BFR procedure and/or exit the LP-WUS monitoring.

The WTRU that detects the one or more LR BFs and/or the one or more MR BFs based on the measured signal quality of the one or more beams associated with the LR (measurements associated with the LR) and/or the MR (measurements associated with the LR) may receive one or more of the following configurations and/or indications from the gNB (e.g., via one or more of the RRC signaling, the MAC-CE indication, and/or DCI indication etc.): one or more BFD configurations, one or more BFD modes, the one or more configurations and/or indications for starting the LP signal monitoring and the one or more LR beams, one or more timer configurations etc.

The WTRU may receive the one or more BFD configurations (e.g., the first MR-BFD configuration information and the second MR-BFD configuration information) associated with the MR. Each MR-BFD configuration (i.e., the first MR-BFD configuration information or the second MR-BFD configuration information) may include a set of RSs (the q_{0, MR}) associated with the MR for the BFD (e.g., the one or more MR resources). In an example, the WTRU may receive a configuration for the q_{0, MR} where the q_{0, MR} may include one or more SSBs, and/or one or more CSI-RSs etc. In an example (e.g., if the WTRU is not configured with the q_{0, MR} by the gNB), the WTRU may determine one or more RSs for the q_{0, MR}. In an example, the WTRRU may determine the one or more (e.g., periodic) RSs for the q_{0, MR} based on one or more activated TCI states for the PDCCH monitoring (e.g., the WTRU may use a RS configured with a quasi co-location (QCL) type set to ‘typeD’ in an activated TCI state in the q_{0, MR}).

Each MR-BFD configuration may include a threshold beam quality (e.g., the RSRP) for the one or more MR resources in the q_{0, MR}. In an example, the WTRU determines the BFI associated with the MR if the WTRU determines beam quality (e.g., the RSRP) of the one or more (e.g., all) RSs in the q_{0, MR} falls below the threshold beam quality for the q_{0, MR}.

Each MR-BFD configuration may include a counter (e.g. the MR-BFI counter) for the BFIs associated with the MR and a timer value (e.g. the MR-BFD timer value) associated with the MR-BFI counter. In an example, if the WTRU detects a BFI associated with the MR when the MR-BFD timer is not running, the WTRU starts the MR-BFD timer and the MR-BFI counter (with initial value 1). If the MR-BFD timer expires before the WTRU detects another BFI associated with the MR, the WTRU resets the MR-BFI counter. If the WTRU detects the MR-BFI before the MR-BFD timer expires, the WTRU increases the MR-BFI counter by 1 and restarts the MR-BFI timer.

Each MR-BFD configuration may include an MR-BFI counter threshold associated with the MR-BFI counter. In an example, the WTRU determines the MR BF in the case the MR-BFI counter exceeds the MR-BFI counter threshold.

The WTRU may receive the configuration and/or indication of the first MR-BFD configuration and the second MR-BFD configuration based on one or more of the following. In an example, the WTRU may receive the MR-BFD configuration (e.g., the second MR-BFD configuration) from the gNB and the one or more configurations and/or parameters and/or offsets to determine the remaining MR-BFD configuration (e.g., the first MR-BFD).

In an example, the first MR-BFD configuration and the second MR-BFD configuration may share a part of configurations and/or parameters. In an example, the first MR-BFD configuration and the second MR-BFD configuration may share all the configurations and/or parameters except the MR-BFI counters and/or the thresholds on the MR-BFI counter (e.g., the first MR-BFD configuration may be configured with the first MR-BFI counter and the first MR-BFI counter threshold, and the second MR-BFD configuration may be configured with the second MR-BFI counter and the second MR-BFI counter threshold (e.g., the second MR-BFI counter threshold is greater than the first MR-BFI counter threshold)). The WTRU may receive the second MR-BFD configuration and a subset of configurations and/or parameters associated with the first MR-BFD configuration (e.g., the second MR-BFI counter and the first MR-BFRI counter threshold etc.). The WTRU may determine the first MR-BFD configuration based on the second MR-BFD configuration received from the gNB and the subset of configurations and/or parameters received from the gNB. In an example, the WTRU may determine the first MR-BFD configuration by replacing and/or substituting a subset of configurations and/or one or more parameters received in the second MR-BFD configuration.

In an example, the WTRU may receive the second MR-BFD configuration and a set of offsets associated with the one or more configurations and/or the one or more parameters. The WTRU may determine the first MR-BFD configuration based on the second MR-BFD configuration and the set of received offsets. In an example, the WTRU may receive the second MR-BFD configuration and an offset for a threshold beam quality for the one or more MR resources in the q_{0, MR}. The WTRU may determine the first MR-BFD configuration by adjusting and/or modifying the threshold associated with a beam quality for the one or more MR resources in the q_{0, MR} in the second MR-BFD configuration based on the received offset.

In an example, the WTRU may receive the first MR-BFD configuration and the second MR-BFD configuration from the gNB (e.g., via one or more of the RRC signaling, the MAC-CE indication, and/or the DCI indication etc.).

The WTRU may receive the BFD configuration (i.e. the LR-BFD configuration) associated with the LR. In an example, the LR-BFD configuration may include one or more of the following: at least one set of LR resources, at least one signal quality threshold, at least one counter, and/or at least one threshold associated with the counter etc.

In the set of LR resources (e.g., the one or more LP-SSs) for the BFD (the q_{0, LR}), the WTRU may receive configuration and/or indication of the one or more LR resources (e.g., the one or more LP-SSs) from the gNB. In an example, e.g., in the case WTRU does not receive the configuration and/or the indication of the q_{0, LR} from the gNB, the WTRU may determine the one or more LR resources for the q_{0, LR} based on one or more of the following. In an example, the WTRU may determine the q_{0, LR} based on the association between one or more LP-WUS monitoring occasion (MOs) and/or one or more LP-WUS occasions (LOs) configured for the LP signal monitoring and the one or more LP resources (e.g., the one or more LP-SSs). In example, the WTRU may receive (e.g., via one or more of the RRC signaling, the MAC-CE indication, and/or the DCI indication etc.) association between the one or more periodic LR resources (e.g., the LP-SSs) and the one or more MOs and/or the one or more LOs. The WTRU may receive (e.g., via one or more of the RRC signaling, the MAC-CE indication, and/or the DCI indication etc.) configuration and/or indication for the one or more LOs and/or MOs to monitor for and/or receive the LP-WUSs. The WTRU may determine the one or more (e.g., periodic) LR resources (e.g., the one or more LP-SSs) associated with the configured LOs and/or MOs for the q_{0, LR}.

In an example, the WTRU may determine the q_{0, LR} based on the RSs, the q_{0, MR} and association between the LR resources and the MR RSs. In an example, the WTRU may receive the association between the one or more LR resources (e.g., the one or more LP-SSs) and the one or more MR RSs (e.g., the one or more MR resources, the SSB, and/or CSI-RSs etc.). The WTRU may determine the one or more LR resources (e.g., the one or more LP-SSs) associated with the q_{0, MR} for the q_{0, LR}.

In an example, the WTRU may receive the signal quality (e.g., the RSRP) threshold for the q_{0, LR}. In an example, the WTRU may receive (e.g., via one or more of the RRC signaling, the DCI indication and/or the MAC-CE indication etc.) a signal quality threshold for the q_{0, LR} from the gNB. In an example, the WTRU may determine the LR signal quality threshold for the q_{0, LR} based on the MR signal quality threshold for the q_{0, MR} and a coverage gap between the LR and the MR (e.g., the LR signal quality threshold for the q_{0, LR}=the MR signal quality threshold for the q_{0, MR}−the coverage gap). In an example, the WTRU may determine the coverage gap between the LR and the MR based on a difference between the measured signal quality (e.g., the RSRP) of the one or more preconfigured (e.g., via one or more of the RRC signaling, the MAC-CE indication, and/or the DCI indication etc.) LR resources (e.g., the one or more LP-SSs) and the one or more MR RSs (e.g., the one or more SSBs) (e.g., the coverage gap between the MR and the LR=an average RSRP of one or more configured MR RSs−an average RSRP of one or more configured LR resources).

In an example, the WTRU may receive (e.g., via one or more of the RRC signaling, the MAC-CE indication, and/or the DCI indication etc.) an offset. The WTRU may determine the LR signal quality threshold for the q_{0, LR} based on the MR signal quality threshold for the q_{0, MR} and the received offset (e.g., the LR signal quality threshold for the q_{0, LR}=the MR signal quality threshold for the q_{0, MR}−the received offset).

In an example, the WTRU may be configured (e.g., via one or more of the RRC signaling, the MAC-CE indication, and/or the DCI indication etc.) with two or more offsets (e.g., a first offset and a second offset). The WTRU may determine the LR signal quality threshold for the q_{0, LR} to be the MR signal quality threshold for the q_{0, MR}+the determined offset. The WTRU may determine an offset among configured two or more offsets based on one or more of the following. In an example, the WTRU may determine the offset based on a difference between the LR and the MR bandwidths (e.g., abs(bandwidth configured for signal transmission or reception via an MR−bandwidth configured for signal transmission or reception via the LR), where operation abs(x) indicates the absolute value of variable x). In an example, the WTRU may determine the first offset if the difference between the LR and the MR bandwidths is less than or equal to a preconfigured (e.g., via one or more of the RRC signaling, the MAC-CE indication, and/or the DCI indication etc.) threshold. The WTRU may determine the second offset if difference between the LR and the MR bandwidth is greater than the preconfigured threshold.

In an example, the WTRU may determine the offset based on a difference between one or more carrier frequencies of the LR and the MR (e.g., abs(operating carrier frequency of MR−operating carrier frequency of LR)). In an example, if the difference between one or more operating carrier frequencies of the LR and the MR is less than or equal to a preconfigured (e.g., via one or more of the RRC signaling, the MAC-CE indication, and/or the DCI indication etc.) threshold, the WTRU may determine the first offset. If the difference between the one or more operating carrier frequencies of the LR and the MR is greater than the preconfigured threshold, the WTRU may determine the second offset.

In an example, the WTRU may determine the offset based on a subcarrier spacing (SCS) of the LP signal. In an example, when the one or more LP signals (e.g., the LP-WUS and/or LP-SS etc.) are based on the OFDM, the WTRU may determine the first offset if the SCS is less than or equal to a preconfigured (e.g., via the one or more of the RRC signaling, the MAC-CE indication, and/or the DCI indication) threshold. The WTRU may select the second offset if the SCS is greater than the preconfigured threshold.

In an example, the WTRU may determine the offset based on a difference between the SCSs of the MR signals and the LR signals. In an example, when the LP signals (e.g., the LP-SS and/or the LP-WUS etc.) are based on the OFDM, the WTRU may determine the first offset if the difference between the SCS of the MR signals and the SCS of the LR signals is less than or equal to the preconfigured (e.g., via one or more of the RRC signaling, the MAC-CE indication and/or DCI indication etc.) threshold. The WTRU may determine the second offset if the difference between the SCS of the MR signals and the SCS of the LR signals is greater than the preconfigured threshold.

In an example, the WTRU may determine the offset based on a coverage gap between the LR and the MR. In an example, the WTRU may determine the first offset if the coverage gap between the LR and the MR is less than or equal to the preconfigured (e.g., via one or more of the RRC signaling, the MAC-CE indication, and/or the DCI indication) threshold. The WTRU may determine the second offset if the coverage gap between LR and MR is greater than the preconfigured threshold.

In an example, the WTRU may determine the offset based on a type of LP receiver (the first type (e.g., OOK based) LP receiver, the second type (e.g., the OFDM based) LP receiving). In an example, if the WTRU is operating with the first type LP receiver, the WTRU may determine the first offset. If the WTRU is operating with the second type LP receiver, the WTRU may determine the second offset.

In an example, WTRU may receive two signal quality (e.g., the RSRP) thresholds (e.g., the first signal quality threshold for the q_{0, LR} and the second signal quality threshold for the q_{0, LR} (e.g., the first signal quality threshold for the q_{0, LR}<the second signal quality threshold for the q_{0, LR}).

The WTRU may receive the counter (e.g. the LR-BFI counter) for the one or more BFIs associated with the LR and the timer (e.g. the LR-BFD timer) associated with the LR-BFI counter. In an example, the WTRU may receive two LR-BFI counters (e.g., a first LR-BFI counter and a second LR-BFI counter) and two LR-BFD timers (e.g., a first LR-BFD timer and a second LR-BFD timer, where the first LR-BFD timer may be associated with the first LR-BFD counter and the second LR-BFD timer may be associated with the second LR-BFD counter).

The WTRU receives the threshold associated with the LR-BFI counter. In an example, the WTRU may determine the threshold associated with the LR-BFI counter based on the gNB indication and/or the configuration (e.g., via one or more of the RRC signaling, the MAC-CE indication, and/or the DCI indication etc.).

In an example, the WTRU may determine the threshold associated with the LR-BFI counter based on threshold associated with the MR-BFI counter. In an example, the threshold associated with the LR-BFI counter=threshold associated with the MR-BFI counter. In an example, the threshold associated with the LR-BFI counter=threshold associated with the MR-BFI counter+a preconfigured (e.g., via one or more of the RRC signaling, the MAC-CE indication, and/or the DCI indication etc.) offset.

In an example, the WTRU may receive (e.g., via one or more of the RRC signaling, the MAC-CE indication, and/or the DCI indication etc.) two or more offsets (e.g., the first offset and the second offset). The WTRU may determine threshold associated with the LR-BFI counter to be threshold associated with the MR-BFI counter+the determined offset. The WTRU may determine the offset among received two or more offsets based on one or more of the following. In an example, the WTRU may determine the offset based on the difference between the LR and the MR bandwidths (e.g., a bandwidth configured for signal transmission or reception via the MR−bandwidth configured for signal transmission or reception via the LR). In an example, if difference between the LR and the MR bandwidth is less than or equal to the preconfigured (e.g., via one or more of the RRC signaling, the MAC-CE indication, and/or the DCI indication etc.), the WTRU may determine the first offset. If the difference between the LR and the MR bandwidth is greater than the preconfigured threshold, the WTRU may determine the second offset.

In an example, the WTRU may determine the offset based on the difference between the one or more carrier frequencies of the LR and the MR (e.g., abs(operating carrier frequency of MR−operating carrier frequency of LR)). In an example, if difference between the carrier frequency of the LR and the MR is less than or equal to a preconfigured (e.g., via one or more of the RRC signaling, the MAC-CE indication, and/or the DCI indication etc.) threshold, the WTRU may determine the first offset. If difference between the carrier frequency of the LR and the MR is greater than the preconfigured threshold, the WTRU may determine the second offset.

In an example, the WTRU may determine the offset based on the SCS of the LP signal. In an example, when the LP signals (e.g., the LP-WUS and the LP-SS etc.) are based on the OFDM, the WTRU may determine the first offset if the SCS is less than or equal to the preconfigured (e.g., via one or more of the RRC signaling, the MAC-CE indication, and/or the DCI indication) threshold. The WTRU may select the second offset if the SCS is greater than the preconfigured threshold.

In an example, the WTRU may determine the offset based on the difference between the SCSs of the MR signals and the LR signals. In an example, when the LP signals (e.g., the LP-SS and/or the LP-WUS etc.) are based on the OFDM, the WTRU may determine the first offset if the difference between the SCS of the MR signal and the SCS of the LR signal is less than or equal to the preconfigured (e.g., via one or more of the RRC signaling, the MAC-CE indication, and/or the DCI indication etc.) threshold. The WTRU may determine the second offset if difference between the SCS of the MR signal and SCS of the LR signal is greater than the preconfigured threshold.

In an example, the WTRU may determine the offset based on the coverage gap between the LR and the MR. In an example, the WTRU may determine the first offset if the coverage gap between the LR and the MR is less than or equal to the preconfigured (e.g., via one or more of the RRC signaling, the MAC-CE indication, and/or the DCI indication etc.) threshold. The WTRU may determine the second offset if the coverage gap between the LR and the MR is greater than the preconfigured threshold.

In an example, the WTRU may determine the offset based on the type of the LP receiver (the first type (e.g., the OOK based) LP receiver, the second type (e.g., the OFDM based) LP receiving). In an example, If WTRU is operating with the first type of the LP receiver, the WTRU may determine the first offset. If the WTRU is operating with the second type of the LP receiver, the WTRU may determine the second offset.

In an example, the WTRU may receive (e.g., via one or more of the RRC signaling, the MAC-CE indication, and/or the DCI indication etc.) two thresholds (e.g., the first threshold and the second threshold) for the first and second LR-BFI counters (e.g., the second threshold is less than or equal to the first threshold).

The WTRU may receive the BFR configuration. In an example, the WTRU may receive (e.g., via one or more of the RRC signaling, the MAC-CE indication, and/or the DCI indication etc.) the BFR configuration. The configured BFR configuration may include of one or more of: one or more sets of candidate beams for the LR (the q_{1, LR}), one or more sets of candidate beams for the MR (the q_{1, MR}), an association between the q_{1, LR} and the q_{1, MR}, a first beam quality threshold, a second beam quality, first sets of PRACHs resources, second sets of PRACHs resources, a search space (BFR SS), and/or a sequence etc.

In an example, the BFR configuration may include the set of candidate beams for the LR (i.e. the q_{1, LR}).

In an example, the BFR configuration may include the set of candidate beams for the MR (i.e. the q_{1, MR}).

In an example, the BFR configuration may include the association between the q_{1, LR} and the q_{1, MR}.

In an example, the one or more beams in the q_{1, MR} may be associated with one or more resource in the q_{1, LR}. The WTRU may determine the association between the one or more RSs in the q_{1, MR} and the one or more resources in the q_{1, LR} based on one or more local indices (a position of resource within the q_{1, LR}, a position of the RS within the q_{1, MR}) of the one or more RSs in the q_{1, MR} and the resource in the q_{1, LR} (e.g., the first resource in the q_{1, LR} is associated with the first L (≥1) RSs in the q_{1, MR}. The second resource in the q_{1, LR} is associated with the second L RSs in the q_{1, LR}, etc.)

The WTRU may determine the association between the one or more RSs in the q_{1, MR} and the one or more resources in the q_{1, LR} based on the gNB indication and/or the configuration (e.g., the WTRU may receive a bitmap for each resource in the q_{1, LR}, where the bit map indicates the RSs in the q_{1, MR} associated with the resource in the q_{1, LR}).

The WTRU may determine the association between the one or more RSs in the q_{1, MR} and the one or more resources in the q_{1, LR} based on the first beam quality (e.g., the RSRP) threshold. In an example, the WTRU may receive the first beam quality threshold for determining the resource among the q_{1, LR} as a new beam for the LR based on the one or more signal quality measurements.

The WTRU may determine the association between the one or more RSs in the q_{1, MR} and the one or more resources in the q_{1, LR} based on the second beam quality (e.g., the RSRP) threshold. In an example, the WTRU may receive the second beam quality threshold for determining a RS among the q_{1, MR} as a new beam for the MR based on the one or more signal quality measurements.

The WTRU may determine the association between the one or more RSs in the q_{1, MR} and the one or more resources in the q_{1, LR} based on the first sets of PRACH resources associated with (e.g., each) RSs in the q_{1, MR}.

The WTRU may determine the association between the one or more RSs in the q_{1, MR} and the one or more resources in the q_{1, LR} based on the second sets of PRACH resources associated with (e.g., each) the RSs in the q_{1, MR}.

The WTRU may determine the association between the one or more RSs in the q_{1, MR} and the one or more resources in the q_{1, LR} based on the BFR SS. In an example, the WTRU may be configured with a SS for receiving a confirmation for a new beam selection via the MR.

The WTRU may determine the association between the one or more RSs in the q_{1, MR} and the one or more resources in the q_{1, LR} based on a sequence (e.g., a BFR sequence) associated with the LP-WUS (e.g., an overlaid OFDM sequence on one or more OOK symbols of the LP WUS). In an example, the WTRU may be configured with the BFR sequence for receiving a confirmation for a new beam selection via the LR.

The WTRU may receive the two BFD modes (e.g., the first BFD mode, and the second BFD mode), and one or more criteria and associated thresholds for selecting the BFD mode. In an example, the WTRU may receive (e.g., via one or more of the RRC signaling, the MAC-CE indication, and/or the DCI indication etc.) one or more of the following thresholds and/or criteria for selecting a BFD mode.

In an example, the WTRU may receive a threshold associated with a DRX cycle duration. In an example, the WTRU may receive a threshold associated with a periodicity of the MR-BFD RSs (e.g., a periodicity of the RS corresponding to the lowest or highest periodicity) associated with the BFD configuration (e.g., the second MR-BFD configuration). In an example, the WTRU may receive a threshold associated with a relative periodicity of the MR-BFD RSs associated with the MR-BFD configuration (e.g., the second MR-BFD configuration) and a periodicity of a CSI-RS resource set (e.g., the resource set that corresponds to a lowest periodicity among periodic resource sets) associated with the CSI reporting.

In an example, the WTRU may receive the threshold associated with the difference between the LR and the MR carrier frequencies. In an example, the WTRU may receive one or more thresholds associated with mobility. In an example, a threshold associated with speed, threshold associated with a doppler shift, a threshold associated with a rate of changing moving direction, etc. In an example, the WTRU may receive a threshold associated with a coverage gap between the LR and the MR. In an example, the WTRU may receive an association between multiple types of the LP signals (e.g., a first type of the LP signal (e.g., the OOK based LP signal), a second type of the LP signal (e.g., the OFDM based LP signal)) and the BFD mode. In an example, the first type LP-signal may be associated with the first BFD mode. The second type LP signal may be associated with the second BFD mode.

In an example, the WTRU may receive one or more configurations and/or indications for starting the LP signal monitoring and the one or more LR beams. In an example, the WTRU may receive the indication and/or configuration (e.g., via one or more of the RRC signaling, the RRC release message, the DCI indication, and/or the MAC-CE indication etc.) to start the LP signal monitoring and/or the one or more beams to be used for the LP signal monitoring. The WTRU may place the MR in the sleep state (e.g., a deep sleep state) and turn on the LR for the LP signal monitoring based on the one or more LR beams configured and/or indicated.

In an example, the WTRU receives a timer (e.g., a ‘potential MR BF evaluation timer’) associated with evaluating the potential MR BFs.

In an example, the WTRU determines the mode of the BFD operation. In an example, the WTRU may determine the mode of BFD operation based on one or more conditions, events, and/or threshold values, etc. In an example, the WTRU may receive, determined, be configured with and/or indicated one or more threshold values and corresponding conditions, based on which the WTRU may determine the mode of the BFD operation. In an example, the WTRU may receive one or more configuration information and/or indications on determining the mode of the BFD operation, in an example from the gNB, in an example via system information block (SIB), the RRC, the MAC-CE, and/or the DCI, etc. In an example, the WTRU may determine, be configured with and/or indicated a first mode of BFD operation, a second mode of BFD operation, and so forth.

In an example, the WTRU may determine the mode of BFD operation based on one or more conditions. In an example, the WTRU may determine the mode of BFD operation based on a DRX cycle duration. In an example, the WTRU may determine, be configured with and/or indicated to use the DRX cycle duration along with the one or more corresponding thresholds as the condition for determining the mode of the BFD operation. In an example, the WTRU may operate based on the first mode of BFD operation if the DRX cycle duration is shorter than a corresponding threshold value. In another example, the WTRU may operate based on the second mode of BFD operation if the DRX cycle duration is longer than the corresponding threshold value.

The WTRU may determine the mode of the BFD operation based on a periodicity of the MR-BFD RSs. In an example, the WTRU may determine, be configured and/or indicated to use the periodicity of the MR-BFD RSs (e.g., associated with the second MR-BFD configuration) along with one or more corresponding thresholds as the condition for determining the mode of BFD operation. In an example, the WTRU may operate based on the first mode of BFD operation if the periodicity of MR-BFD RSs is shorter than the corresponding threshold value. In another example, the WTRU may operate based on the second mode of BFD operation if the periodicity of MR-BFD RSs is longer than the corresponding threshold value.

In another example, the WTRU may determine, be configured with and/or indicated to use the periodicity of the MR-BFD RSs in comparison with the periodicity of the one or more CSI-RS resources and/or the CSI-RS resource sets etc. In an example, the WTRU may compare the periodicity of the MR-BFD RSs resource set with a first periodic CSI-RS resource set with the shortest periodicity out of the periodic resource sets. In an example, the WTRU may determine a delta time value between the periodicity of the MR-BFD RSs resource sets with the periodicity of the first periodic CSI-RS resource set. The WTRU may determine the delta time value based on absolute time units (e.g., millisecond, microsecond, etc.) and/or one or more time instances (e.g., number of symbols, slots, and/or subframes, etc.). In an example, the WTRU may determine to operate based on the first mode of BFD operation if the calculated delta time value is longer than a corresponding threshold value. The WTRU may determine to operate based on the second mode of BFD operation if the calculated delta time value is shorter than the corresponding threshold value, and so forth. In another example, the WTRU may calculate the ratio between the periodicity of the first periodic CSI-RS resource set and the periodicity of the MR-BFD RSs. In an example, the WTRU may determine to operate based on the first mode of BFD operation if the calculated ratio is larger than a corresponding threshold value (e.g., value 2). The WTRU may determine to operate based on the second mode of BFD operation if the calculated delta time value is smaller than the corresponding threshold value, and so forth.

The WTRU may determine the mode of BFD operation based on the LR and the MR carrier frequencies. In an example, the WTRU may determine, be configured with, and/or indicated to use the difference between the LR and the MR carrier frequencies along with one or more corresponding thresholds as the condition for determining the mode of the BFD operation. In an example, the WTRU may operate based on the first mode of BFD operation if the difference between the LR and the MR carrier frequencies is smaller than a corresponding threshold value. In another example, the WTRU may operate based on the second mode of the BFD operation if the difference between the LR and the MR carrier frequencies is larger than the corresponding threshold value.

The WTRU may determine the mode of the BFD operation based on the LR and the MR coverage. In an example, the WTRU may determine, be configured with and/or indicated to use the difference and/or the ratio between the LR and the MR coverage along with one or more corresponding thresholds as the condition for determining the mode of the BFD operation. In an example, the WTRU may use one or more measured, determined, and/or calculated quality parameters for determining the LR and/or the MR coverage. In an example, the WTRU may determine the LR and/or the MR coverage based on the measured received power (e.g., the RSRP, the RSSI, etc.), the received signal quality (e.g., the RSRQ, the CQI, etc.), the signal to interference ratio (e.g., the SINR), and so forth. The WTRU may calculate the ratio by dividing the first quality parameter measured in the MR to the same quality parameter measured in the LR. In an example, the WTRU may operate based on the first mode of BFD operation if the calculated ratio is smaller than a corresponding threshold value. In another example, the WTRU may operate based on the second mode of the BFD operation if the calculated ratio is larger than the corresponding threshold value.

The WTRU may determine the mode of BFD operation based on mobility. In an example, the WTRU may determine, be configured and/or indicated to use the mobility status of the WTRU along with one or more corresponding thresholds as a condition for determining the mode of BFD operation. In an example, the WTRU may operate based on the first mode of the BFD operation if the speed of the WTRU is lower than a corresponding threshold value. In another example, the WTRU may operate based on the second mode of BFD operation if the speed of the WTRU is higher than the corresponding threshold value.

The WTRU may determine the mode of the BFD operation based on the LP-WUS type. In an example, the WTRU may determine, be configured with, and/or indicated to use the LP-WUS type and/or the type of LR that is being used as the condition for determining the mode of the BFD operation. In an example, the WTRU may operate based on the first mode of the BFD operation if the WTRU uses a first type of the LP-WUS. The WTRU may operate based on the second mode of BFD operation if the WTRU uses a second type of the LP-WUS, and so forth. In an example, the WTRU may use the OFDM-based LR in the first type of the LP-WUS, whereas the WTRU may use the OOK-based LR in the second type of LP-WUS. As such, the WTRU may determine the mode of the BFD operation based on the LR that is used for monitoring, detecting, and/or receiving the LP-WUS.

In an example, the WTRU may determine, be configured with and/or indicated one or more modes of the BFD operation. One or more of the following example modes of the BFD operation may apply. In an example, the WTRU may determine, be configured with and/or indicated the first mode of BFD operation (e.g. a BFD based on the one or more LR measurements). In an example, in the first mode of the BFD operation, the WTRU may monitor and/or measure one or more first BFD-RSs (e.g., one or more configured LR resources for BFD in the LR-BFD configuration). In an example, the first BFD-RSs may be based on the one or more LP signaling. In an example, the first BFD-RSs may be based on the one or more LP-SSs, the LP-WUSs, etc. In case the WTRU determines that one or more measured quality parameters based on the first BFD-RSs is lower than corresponding thresholds (e.g., a preconfigured number of times consecutively), the WTRU may determine to wake up the MR. Upon waking up the MR, the WTRU may monitor and/or measure the one or more second BFD-RSs (e.g., the BFD-RSs associated with the MR-BFD configuration). In an example, the second BFD-RSs may be based on the MR signaling. In an example, the second BFD-RSs may be based on the SSBs, the CSI-RSs, etc. In case the WTRU determines that the one or more measured quality parameters based on the second BFD-RSs is lower than the corresponding thresholds (e.g., a preconfigured number of times), the WTRU may perform the BFR, where the WTRU may select the new beams for the MR and/or the LR.

In an example, the WTRU operating based on the first mode of BFD operation may determine that the measured quality parameters based on the first BFD-RSs is lower than the first corresponding threshold. However, the WTRU may determine that the quality of the received LP reference signals is still within the acceptable range for the LP-WUS operation. That is, the WTRU may determine that the measured quality parameters based on the first BFD-RSs is higher than the second threshold. As such, the WTRU may postpone the BFR procedure. The WTRU may not wake up the MR for the BFR procedure. The WTRU may wake up the MR only upon reception of the LP-WUS that requires the MR to wake up. In case of receiving the LP-WUS for waking up the MR, the WTRU may wake up the MR based on a second and/or new timer. That is the WTRU may wake up the MR earlier than a normal DRX inactive time duration to give enough time to the MR to perform the BFR procedure. After performing the BFR procedure, the WTRU may select the new beam for the MR and/or the LR. The WTRU may monitor to receive the PDCCH and/or other signals or channels via the MR based on the selected new beams.

The WTRU may determine, be configured with, and/or indicated the second mode of the BFD operation (e.g. the BFD based on the MR measurements). In an example, in the second mode of BFD operation, the WTRU may periodically wake up the MR to monitor and/or measure the one or more BFD-RSs in the MR. In an example, the WTRU may measure the SSBs, the CSI-RSs, etc. In case the WTRU determines that the one or more measured quality parameters based on the BFD-RSs is lower than the corresponding thresholds (e.g., a preconfigured number of times consecutively), the WTRU may perform the BFR, where the WTRU may select a new beam for the MR and/or the LR.

The WTRU may monitor for the LR BFs and/or the MR BFs, and/or the potential MR BFs based on the quality of the LP signals. The WTRU operating in the LP mode may measure the beam equality of the q_{0, LR} and/or the q_{0, MR} to detect the one or more of the LR BFs, the MR BFs, and/or the potential MR BFs etc. In an example, the WTRU may (e.g., periodically) measure the quality (e.g., the RSRP) of the one or more (e.g., all) resources in the q_{0, LR}. The WTRU may (e.g., periodically) measure the quality (e.g., the RSRP) of the one or more (e.g., all) beams in the q_{0, MR}. To this end, while operating in the LP mode, the WTRU may (e.g., periodically) wake-up the MR to measure the one or more (e.g., all) RSs in the q_{0, MR}. Time duration for which the WTRU may keep awake the MR for measuring the one or more (e.g., all) RSs in the q_{0, MR} may be limited to a preconfigured (e.g., via the one or more of the RRC signaling, the MAC-CE indication, and/or the DCI indication etc.) duration.

In an example, based on the signal quality (e.g., the RSRP) measurements associated with the q_{0, LR} and/or the q_{0, MR}, the WTRU may detect the one or more of the LR BFs, the MR BFs, and/or the potential MR BFs etc. To this end, the WTRU may use one or more of the following procedures. In an example, the WTRU may determine the potential MR BF (i.e., the LR BF) based on the measured signal quality of the q_{0, LR}. The WTRU detecting the one or more potential MR BFs may be based on one or combination of the following steps and/or procedures. In an example, the WTRU may determine the potential MR BF based on (e.g., periodic) signal quality measurements associated with resources of the q_{0, LR}, and the WTRU may update the LR-BFI counter. In an example, if the WTRU determines that measured quality (e.g., the RSRP) of one or more (e.g., all) resources in the q_{0,LR} is less than the signal quality threshold for the q_{0, LR}, the WTRU may determine the LR BFI. In an example, if the LR BFD timer is not running, the WTRU may start the LR BFD timer, start or restart the LR-BFI counter (e.g., set the LR-BFI counter to zero), and increase the LR-BFI counter by a preconfigured step size (e.g., 1). In an example, if the LR-BFD timer is running the WTRU may increase the LR-BFI counter by a preconfigured (e.g., via one or more RRC signaling, MAC-CE indication, DCI indication) step size (e.g., 1) and restart the LR-BFD timer. In an example, if the LR-BFI counter becomes equal to or exceeds the corresponding threshold, the WTRU may determine the potential MR BF.

In an example, the WTRU may detect the MR BF and/or the potential MR BF based on the signal quality (e.g., the RSRP) measurements associated with the one or more (e.g., all) resources of the q_{0, LR}. In an example, the WTRU may detect the MR BF and/or the potential MR BF based on detection of two types (e.g., a first type LR BF and a second type LR BF) of the LR BFs where each type of the LR BF may correspond to a different signal quality threshold for the q_{0, LR}. In an example, the WTRU may detect the first type of LR BFs based on the first threshold associated with the signal quality for the q_{0, LR}, the first threshold associated with the LR-BFI counter, and the first LR-BFI timer. In an example, if the WTRU determines that the measured signal quality (e.g., the RSRP) of the one or more (e.g., all) resources in the q_{0,LR} is less than the first threshold associated with signal quality for the q_{0, LR}, the WTRU may determine the LR-BFI associated with the first type of LR BF.

In an example, if the first LR BFD timer is not running, the WTRU may restart the first LR-BFD timer, start or restart the first LR-BFI counter (e.g., set the first LR-BFI counter to zero) and increase the first LR-BFI counter by a preconfigured step size (e.g., 1).

In an example, if the first LR-BFD timer is running, the WTRU may increase the first LR-BFI counter by the preconfigured (e.g., via the one or more RRC signaling, the MAC-CE indication, and/or the DCI indication etc.) step size (e.g., 1) and restart the first LR-BFD timer.

In an example, if the first LR-BFI counter becomes equal to or exceeds the first LR-BFI counter threshold, the WTRU may determine the first type of LR BF.

In an example, the WTRU may detect the second type of LR BFs based on the second threshold associated with the signal quality for the q_{0, LR}, the second threshold associated with the LR-BFI counter, and the second LR-BFD timer. In an example, if the WTRU determines that the measured signal quality (e.g., the RSRP) of the one or more (e.g., all) resources in the q_{0,LR} is less than the second threshold associated with the signal quality for the q_{0, LR}, the WTRU may determine the LR-BFI associated with the second type of LR BF.

In an example, if the second LR-BFD timer is running, the WTRU may increase the second LR-BFI counter by the preconfigured (e.g., via one or more the RRC signaling, the MAC-CE indication and/or the DCI indication etc.) step size (e.g., 1) and restart the second LR-BFD timer.

In an example, if the second LR-BFD timer is not running, the WTRU may restart the second LR-BFI counter (e.g., set the second LR-BFI counter to zero) and increase second the LR-BFI counter by the preconfigured step size (e.g., 1).

In an example, if the second LR-BFI counter becomes equal to or exceeds the second LR-BFI counter threshold, the WTRU may determine the second type of LR BF.

In an example, based on the one or more types of the LR BFs, i.e., the first type LR BF and/or the second type of the LR BF, the WTRU may determine the occurrence of the MR BF and/or the potential MR BF. In an example, if the WTRU detects the first type LR BF only (e.g., the WTRU determines the first type of LR BF and has not determined the second type of LR BF yet), the WTRU may determine the potential MR BF (i.e., the LR BF).

If the WTRU detects at least the second type of the LR BF (e.g., if the WTRU detects the second type of the LR BF, or the WTRU detects the second type of the LR BF and the first type of the LR BF at the same time), the WTRU may determine the MR BF.

In an example, the WTRU may determine the MR BF and the LR BF based on the one or more signal quality measurements associated with the q_{0, LR}. In an example, when each MR beam is associated with an LR beam (e.g., when the LP signals are based on the OFDM and/or the WTRU share one or part of radio hardware), the WTRU may monitor the beam quality of the q_{0, LR}. The WTRU may consider detection of the LR BF based on the signal quality of the q_{0, LR} as the detection of the MR BF. In an example, the WTRU may determine the MR BF and the LR BF based on (e.g., periodic) signal quality measurements associated with the resources of the q_{0, LR}, the WTRU may update the LR-BFI counter. In an example, if the WTRU determines that the measured quality (e.g., the RSRP) of the one or more (e.g., all) resources in the q_{0,LR} is less than the signal quality threshold for the q_{0, LR}, the WTRU may determine the LR BFI.

In an example, if the LR BFD timer is not running, the WTRU may start the LR BFD timer, start or restart the LR-BFI counter (e.g., se LR-BFI counter to zero), and increase the LR-BFI counter by the preconfigured step size (e.g., 1).

In an example, if the LR-BFD timer is running the WTRU may increase the LR-BFI counter by the preconfigured (e.g., via the one or more RRC signaling, the MAC-CE indication, and/or the DCI indication etc.) step size (e.g., 1) and restart the LR-BFD timer.

In an example, if the LR-BFI counter becomes equal to or exceeds its threshold, the WTRU may determine the MR BF and the LR BF.

The WTRU may evaluate the potential MR BF based on the MR measurements. In an example, when the WTRU determines the potential MR BF, the WTRU may turn on the MR and evaluate the detected potential MR BF within a preconfigured (e.g., via one or more the RRC signaling, the MAC-CE indication, the DCI indication etc.) time window. In an example, the WTRU may start the potential MR BF evaluation timer and while the timer is running the WTRU may evaluate the determined potential MR BF. In an example, the WTRU may wake-up the MR and evaluate the determined potential MR BF based on the first MR-BFD configuration. The WTRU evaluating the detected potential MR BF based on the first MR-BFD configuration may include measuring (e.g., periodically) the signal quality of the one or more BFD RSs associated with the first MR-BFD configuration (e.g., the first q_{0,MR}). If the WTRU determines that the signal quality of one or more (e.g., all) RSs in the first q_{0,MR} is less than the threshold signal quality associated with the first MR-BFD configuration (threshold associated with the first q_{0,MR}), the WTRU determines the MR-BFI.

In an example, if the MR-BFD timer associated with the first MR-BFD configuration (e.g., the first MR-BFD timer) is not running, the WTRU may start the first MR-BFD timer, start or restart the MR-BFD counter associated with the first MR-BDF configuration (e.g., the first MR-BFI counter) (e.g., set the first MR-BFI counter to zero) and increase the first MR-BFI counter by the preconfigured step size (e.g., 1).

In an example, if the first MR-BFD timer is running, the WTRU may increase the first MR-BFI counter by the preconfigured (e.g., via the one or more RRC signaling, the MAC-CE indication, and/or the DCI indication etc.) step size (e.g., 1) and restart the first MR-BFD timer.

In an example, if the first MR-BFI counter becomes equal to or exceeds the threshold associated with the MR-BFI counter associated with the first MR-BFD configuration before the potential MR BF evaluation timer expires, the WTRU may determine the MR BF (the WTRU determines the potential MR BF to be the MR BF). If the potential MR BF evaluation timer expires before the WTRU determines the MR BF, the WTRU may determine a false MR BF alarm and may exit evaluating the potential MR BF.

In an example, the WTRU may evaluate the determined potential MR BF based on the second MR-BFD configuration. The WTRU evaluating the potential MR BF based on the second MR-BFD configuration may include the WTRU measuring (e.g., periodically) the signal quality of the one or more BFD RSs associated with the second MR-BFD configuration (e.g., the second q_{0,MR}). If the WTRU determines that the signal quality of the one or more (e.g., all) RSs in the second q_{0,MR} is less than the threshold associated with the signal quality associated with the second MR-BFD configuration (e.g., the threshold associated with the second q_{0,MR}), the WTRU determines the MR-BFI.

In an example, if the MR-BFD timer associated with the second MR-BFD configuration (e.g. the second MR-BFD timer) is not running, the WTRU may restart the second MR-BFD timer, start and/or restart the MR-BFI counter associated with the second MR-BFD configuration (e.g. the second MR-BFI counter) (e.g., set the second MR-BFI counter to zero) and increase the second MR-BFI counter by the preconfigured step size (e.g., 1).

In an example, if the second MR-BFD timer is running, the WTRU may increase the second MR-BFI counter by the preconfigured (e.g., via one or more of the RRC signaling, the MAC-CE indication, and/or the DCI indication etc.) step size (e.g., 1) and restart the second MR-BFD timer.

If the second MR-BFI counter becomes equal to or exceeds the threshold associated with the MR-BFI counter associated with the second MR-BFD configuration before the potential MR BF evaluation timer expires, the WTRU may determine the MR BF (the WTRU determines the potential MR BF to be the MR BF). If the potential MR BF evaluation timer expires before the WTRU determines the MR BF, the WTRU may determine the false MR BF alarm and may exit evaluating the potential MR BF.

While the WTRU is evaluating the detected potential MR BF, the WTRU may monitor for the LP signals (e.g., the LP-WUS, the LP-SSs etc.). If the WTRU receives an indication to wake-up, the WTRU may wake-up the MR for the PDCCH monitoring.

In an example, the WTRU may monitor for the PDCCHs based on the DRX configuration. In an example, the WTRU may start timers (e.g., the drx-onDurationTimer) configured by the DRX configuration for the PDCCH monitoring and monitor for and receive the PDCCHs.

In an example, the WTRU may monitor for the PDCCHs based on the PDCCH monitoring timers associated with the LP-WUS configuration. In an example, the WTRU may be configured (e.g., via one or more of the RRC signaling, the MAC-CE indication, and/or the DCI indication etc.) with (e.g., periodic) one or more starting points of the timer for the PDCCH monitoring. The WTRU may wake-up the MR (e.g., periodically) and monitor for the PDCCHs in each PDCCH monitoring timer until the potential MR BF is evaluated.

The WTRU may recover from the one or more beam failures. The WTRU that determines the MR BF (e.g., based on the WTRU determining that the potential MR BF is the MR BF and/or the WTRU that determines the MR BF based on the signal quality measurements on the q_{0,LR} and the LR-BFD configuration) may recover from the determined MR BF. In an example, the WTRU may measure the signal quality (e.g., RSRP) of the candidate beams associated with the MR and/or the candidate beams associated with the LR.

In an example, the WTRU may measure the signal quality of the q_{1,MR} via the MR and the q_{1,MR} via the LR.

In an example, the WTRU may measure the signal quality of the q_{1,LR} via the LR and measure the signal quality of the subset of the q_{1,MR} selected based on the measured signal quality of the q_{1,LR} and the association between the one or more RSs in the q_{1,MR} and the q_{1,LR}. In an example, the WTRU may measure the signal quality of the q_{1, LR} via the LR. The WTRU may select the subset of the q_{1, LR} of which the measured signal quality exceeds the preconfigured (e.g., via one or more of the RRC signaling, the MAC-CE indication, and/or the DCI indication) threshold. The WTRU may select the one or more RSs among the q_{1,MR} associated with the selected subset of the q_{1,LR}. Subsequently, the WTRU may measure the signal quality of the selected subset of the q_{1,MR} via the MR.

In an example, the WTRU may measure the signal quality of the q_{1,MR} via the MR and measure the signal quality of a subset of the q_{1,LR} selected based on the measured signal quality of the q_{1,MR} and the association between the one or more RSs in the q_{1,MR} and the q_{1,LR}. In an example, the WTRU may measure the signal quality of the q_{1, MR} via the MR. the WTRU may select a subset of the q_{1, MR} of which the measured signal quality exceeds the preconfigured (e.g., via one or more of the RRC signaling, the MAC-CE indication, and/or the DCI indication etc.) threshold. The WTRU may select resource among the q_{1,LR} associated with the selected subset of the q_{1,MR}. Subsequently, the WTRU may measure the signal quality of the selected subset of the q_{1,LR} via the LR.

In an example, the WTRU may select a new beam for the MR (the q_{new, MR}) and/or a new beam for the LR (the q_{new, LR}) based on the measured signal quality of the one or more RSs in the q_{1,MR} and the one or more resources in the q_{1,LR}.

In an example, the WTRU may select one or more new beams for the LR and/or the MR in terms of one or more beam pairs. In an example, the WTRU may determine one or more candidate beam pairs based on the association between beams in the q_{1,LR} and beams in the q_{1,MR}. In an example, the first candidate beam in the q_{1,LR} and the candidate beam in the q_{1,MR} associated with the first candidate beam in the q_{1,LR} may form the candidate beam pair.

If one candidate beam pair meets one or more beam quality thresholds (e.g., the signal quality of associated candidate beam in the q_{1,LR} is greater than or equal to the first beam quality threshold and the signal quality of associated candidate beam in the q_{1,MR} is greater than or equal to the second beam quality threshold), the WTRU may select the candidate beam pair as the new beam pair, i.e., the new beam for the LR (the q_{new, LR}) and the new beam for the MR (the q_{new, MR}). If more two or more candidate beam pairs meet beam quality thresholds, the WTRU may select the candidate beam pair for new beam pair based, e.g., the beam quality of the LR candidate beam (i.e. the candidate beam in the q_{1,LR}) associated with the candidate beam pairs. In an example, the WTRU may select candidate beam pair with a highest signal quality LR candidate beam among the two or more candidate beam pairs meeting the one or more signal quality thresholds.

The WTRU may select the candidate beam pair for the new beam pair based on the beam quality of the MR candidate beam (candidate beam in the q_{1,MR}) associated with the candidate beam pairs. In an example, the WTRU may select the candidate beam pair with the highest signal quality MR candidate beam among the two or more candidate beam pairs meeting the signal quality thresholds.

The WTRU may select the candidate beam pair for the new beam pair based on an average beam quality of the two candidate beams (e.g., the candidate beam associated with the q_{1,LR,} and the candidate beam associated with the q_{1,MR}). In an example, the WTRU may select the candidate beam pair with the highest average LR and MR candidate beams among the candidate beam pairs meeting the one or more signal quality thresholds.

In an example, if none of the candidate beam pairs meets the one or more beam quality thresholds and at least one candidate beam associated with the MR meets the second beam quality threshold, the WTRU may select a (e.g., best in terms of the signal quality) new beam for MR, i.e., the q_{new, MR}.

In an example, the WTRU may indicate the MR BF and the selected new beam pair (new beam for the LR (the q_{new, LR}) and the new beam for (the q_{new, MR})) or the selected new beam for the MR (the q_{new, MR}) to the gNB. The WTRU may receive the confirmation for indicated one or more new beams from the gNB via the LP-WUS and/or the DCI and/or via the BFR SS. In an example, if the WTRU determines the new beam pair, the WTRU may indicate the selected new beam pair and receive the confirmation for the beam pair selection based on one or more of the following, for example, the WTRU may select the PRACH resource among the first set of PRACH resources based on the selected new beam for the MR, i.e., the q_{new, MR}, in the selected new beam pair. The WTRU may transmit the selected PRACH resource to the gNB via the MR. The WTRU may receive the confirmation from the gNB for the new beam pair selection via the LP-WUS. In an example, after indicating the new beam pair, the WTRU may resume (e.g., starting from the next occurrence of the LP-WUS MO and/or LO after a preconfigured (e.g., via one or more of the RRC signaling, the MAC-CE indication, and/or the DCI indication) time offset) monitor for and/or receive the LP signals (e.g., the LP-WUS) based on the q_{new, LR} (e.g., the LR beam in the selected new beam pair).

In an example, if the WTRU receives the LP-WUS with the BFR sequence (e.g., overlaid OFDM sequence on the OOK signal) within the preconfigured (e.g., via the one or more RRC signaling, the MAC-CE indication, and/or the DCI indication) time window, the WTRU may determine that the new beam pair selection is confirmed by the gNB. The WTRU may continue to monitor for the LP signals (i.e. operate in the LP mode) based on the q_{new, LR}. After resuming the LP signal monitoring based on the q_{new, LR}, if the WTRU receives an indication via the LP-WUS to wake-up, the WTRU may wake up the MR and monitor for and/or receive the PDCCHs based on the q_{new, MR}.

If the WTRU does not receive the LP-WUS with the BFR sequence within a preconfigured time window, the WTRU may perform one or more of the following, for example, the WTRU may perform initial access to reconnect to the network.

If the WTRU does not receive the LP-WUS with the BFR sequence within the preconfigured time window, the WTRU may exit the LP signal monitoring and monitor for and/or receive the PDCCHs based on the DRX configuration. The WTRU may use the indicated new MR beam (the q_{new, MR}) associated with the new beam pair for monitoring and receiving the PDCCHs.

If the WTRU does not receive the LP-WUS with the BFR sequence within the preconfigured time window, the WTRU attempts to indicate the selected new beam pair by transmitting an indication for the new beam pair selection with an increased transmit power (e.g., the increased transmit power based on a preconfigured (e.g., via one or more of the RRC signaling, the MAC-CE indication, and/or the DCI indication) step size. The WTRU may receive a confirmation indication for the new beam selection via the BFR SS. If the WTRU receives the confirmation indication, the WTRU may resume the LP signal monitoring based on the new LR beam (the q_{new, MR}) of the selected new beam pair. If the WTRU fails to receive the confirmation indication from the gNB, the WTRU may perform the initial access to reconnect to the network.

If the WTRU does not receive the LP-WUS with the BFR sequence within the preconfigured time window, the WTRU exits monitoring the LP signals and selects the new beam for the MR. In an example, the WTRU exits the LP signal monitoring and selects the new beam for the MR based on the signal quality measurements on the q_{1,MR}. The WTRU may indicate the elected beam for the MR and that the WTRU is exiting the LP signal monitoring based on the detection of the BF. In an example, the WTRU transmits the PRACH resource among the second set of PRACH resources associated with the selected new beam for the MR. The WTRU may receive the confirmation indication for the new MR beam via the BFR SS within the preconfigured (e.g., via one or more of RRC signaling, MAC-CE indication, DCI indication) time window.

If the WTRU determines the new beam for the MR (not the new beam pair), i.e., the q_{new, MR}, the WTRU may exit the LP signal monitoring and indicate selected the new beam for the MR to the gNB. The WTRU may receive the confirmation for the new MR beam selection from the gNB. To this end, the WTRU may select the PRACH resource among the second set of PRACH resources based on the selected new MR beam, i.e., the q_{new, MR}.

In an example, the WTRU may transmit the selected PRACH resource to the gNB via the MR.

In an example, the WTRU may monitor for and/or receive the confirmation indication for the new MR beam via the BFR SS within the preconfigured (e.g., via one or more of RRC signaling, MAC-CE indication, DCI indication) time window.

If the WTRU receives the confirmation indication for the new MR beam selection from the gNB, the WTRU may continue to operate based on the DRX configuration. While operating based on the DRX configuration, the WTRU may perform the BFD based on the second MR-BFD configuration.

If the WTRU fails to receive the confirmation indication for the new MR beam within the configured time window, the WTRU may perform the initial access to reconnect to the network.

In an example, the WTRU may recover from a false MR BF alarm. If the WTRU determines that the potential MR BF is a false MR BF alarm, the WTRU may exit the LP-WUS monitoring. In an example, the WTRU may operate based on the DRX configuration associated with the LP-WUS monitoring and transmit the indication (e.g., via the PUCCH) to the gNB. After exiting the LP-WUS, the WTRU may perform the BFD based on the second MR-BFD configuration.

In an example, the WTRU determines one or more available LR beams for the LP signal monitoring and reports the determined available beams to the gNB. In an example, the WTRU may measure the signal quality of the q_{1, LR} via the LR and determine one or more available candidate beams (e.g., beams in the q_{1, LR} meeting the signal quality threshold for the q_{1, LR}). The WTRU may report the one or more available candidate beams to the gNB via the MR (e.g., via the PUCCH, the PUSCH etc.).

In an example, the WTRU receives an indication for the new LR beam from the gNB (e.g., via one or more of the RRC signaling, the MAC-CE indication, and/or the DCI indication etc.)

In an example, the WTRU resumes monitoring the LP signals based on the new LR beam indicated and/or configured by the gNB.

The WTRU may support the gNB to update the LR-BFD configuration and/or the MR-BFD configuration. The WTRU may assist the gNB to determine and/or adjust one or more configurations and/or parameters associated with the LR-BFD configuration and/or the MR-BFD configuration and/or the BFR configuration by reporting the one or more measurements and/or indications and/or reports via the preconfigured (e.g., via one or more of the RRC signaling, the MAC-CE indication, and/or the DCI indication etc.) UL resources (e.g., the PUCCH, the PUSCH etc.).

In an example, the WTRU may measure and report (e.g., periodically) the LR beam (e.g., the RSRP) measurements associated with the preconfigured (e.g., via one or more of the RRC signaling, the MAC-CE indication, and/or the DCI indication etc.) set of LR resources (e.g., the LP-SSs)

In an example, the WTRU may measure and report a difference between the beam quality (e.g., the average RSRP) of the one or more preconfigured (e.g., via one or more of the RRC signaling, the MAC-CE indication, and/or the DCI indication etc.) LR resources (e.g., the LP-SSs) and the beam quality (e.g., the average RSRP) associated with the preconfigured (e.g., via one or more of the RRC signaling, the MAC-CE indication, and/or the DCI indication etc.) set of MR RSs (e.g., the SSBs, the CSI-RSs etc.).

In an example, the WTRU may report a rate of false MR BF alarms.

In an example, if the WTRU detects the rate of the false MR BF alarms (e.g., a number of the false MR BF alarms within a preconfigured time window) greater than a preconfigured (e.g., via preconfigured PUCCH resource via one or more of the RRC signaling, the MAC-CE indication, and/or DCI indication etc.) threshold, the WTRU may report (e.g., via the preconfigured PUCCH resource via one or more of the RRC signaling, the MAC-CE indication, and/or the DCI indication etc.) rate of the false MR BF alarms to the gNB. In an example, the WTRU may transmit an indication (e.g., 1 bit indication via a PUCCH) indicating that the rate of the false MR BF alarms exceeds the preconfigured threshold.

In an example, the WTRU may periodically report the rate of false alarms to the gNB via the preconfigured (e.g., via the preconfigured PUCCH resources via one or more of the RRC signaling, the MAC-CE indication, and/or the DCI indication etc.) UL resources (e.g., the PUCCH).

In response to reported measurements and/or reports and/or indications (e.g., the LR beam quality, and/or status indication (e.g., the rate of false MR BF alarms is greater than a preconfigured threshold), the WTRU may receive one or more indications and/or configurations to adjust one or more configurations and/or parameters associated with the LR-BFD configuration and/or the MR-BFD configurations and/or the BFR configurations. The one or more configurations and/or parameters may include the threshold associated with the LR-BFI counter, the threshold associated with the MR-BFI counter, the threshold associated with the signal quality for the q_{1,LR}, threshold associated with the signal quality for the q_{1,MR}.

In an example, the WTRU may receive 1-bit indication where bit value 1 may correspond to increasing the LR beam quality threshold for the q_{0, LR} by a preconfigured (e.g., via one or more of the RRC signaling, the MAC-CE indication and/or the DCI indication etc.) step size. The 1 bit indication of value 0 may correspond to keeping the beam quality threshold for the q_{0, LR} unchanged.

In an embodiment, the WTRU may perform the BFR via the LP-WUS.

The WTRU monitoring the LP signals (i.e. operating in the LP mode), may monitor for the MR BF and the LR BF. The WTRU may detect, based on the one or more BFs (e.g., the MR BF only, the LR BF only, or both the LR BF and the MR BF), a mode of operation (e.g., continue to operate in the LP mode while the MR is in an outage state, recover the MR BF and/or resume to operate in the LP mode).

The WTRU may receive one or more configurations. The WTRU may receive the one or more configurations and/or indications from the gNB via one or more of the RRC signaling, the MAC-CE indication, and/or the DCI indication etc. The WTRU may start to operate in the LP mode based on the one or more received indications and/or configurations.

The WTRU may receive the BFD configuration (e.g., the MR-BFD configuration) associated with the MR. In an example, the MR-BFD configuration may include a set of MR RSs for the BFD (the q_{0, MR}). In an example, the WTRU may receive configuration of the one or more CSI RSs and/or the one or more SSBs for the q_{0, MR}. In an example, e.g., if the WTRU is not configured with the q_{0, MR} by the gNB, the WTRU may determine the one or more RSs for the q_{0, MR}. In an example, the WTRU may determine the one or more (e.g., periodic) RSs for the q_{0, MR} based on one or more activated TCI states for the PDCCH monitoring (e.g., the WTRU may use the RS configured with a quasi co-location (QCL) type set to ‘typeD’ in the activated TCI state in the q_{0, MR}).

In an example, the MR-BFD configuration may include a threshold signal quality (e.g., the RSRP) for the q_{0, MR}. In an example, the MR-BFD configuration may include a counter (MR-BFI counter) for counting a number of MR BFIs. In an example, the MR-BFD configuration may include a threshold associated with the MR-BFI counter for determining the MR BF.

In an example, the MR-BFD configuration may include a timer (e.g., the MR-BFD timer) associated with the MR-BFI counter.

The WTRU may receive the BFD configuration (e.g. the LR-BFD configuration) associated with the LR. The LR-BFD configuration may include a set of LR resources (e.g., the LP-SSs) for the BFD (the q_{0, LR}). In an example, the LR-BFD configuration may include a threshold associated with the signal quality (e.g., the RSRP) for the q_{0, LR}. In an example, the LR-BFD configuration may include a counter (e.g., the LR-BFI counter) for counting a number of the LR BFIs.

In an example, the LR-BFD configuration may include a threshold LR-BFI counter value for determining the LR BF.

In an example, the LR-BFD configuration may include a timer (e.g., the LR-BFD timer) associated with the LR BFI counter.

The WTRU may receive the BFR configuration which may include a set of candidate beams for the LR (the q_{1, LR}). The BFR configuration may include a set of candidate beams for the MR (the q_{1, MR}). The BFR configuration may include the first beam quality threshold for selecting the new beam among the q_{1, LR} for the LR. The BFR configuration may include the second beam quality threshold for selecting the new beam among the q_{1, MR} for the MR.

The BFR configuration may include the first set of PRACH resources and an association between the first set of PRACH resources and one or more beams in the q_{1, LR} (e.g., each PRACH resource is the first set of PRACH resources is associated with a beam in the q_{1, LR}).

The BFR configuration may include the second set of PRACH resources and an association between the second set of PRACH resources and one or more beams in the q_{1, MR} (e.g., each PRACH resource in the second set of PRACH resources is associated with a beam in the q_{1, MR}).

The BFR configuration may include the third set of PRACH resources and an association between the third set of PRACH resources and one or more beams in the q_{1, MR} (e.g., each PRACH resource in the third set of PRACH resources is associated with a beam in the q_{1, MR}).

The BFR configuration may include the fourth set of PRACH resources and an association between the fourth set of PRACH resources and one or more beams in the q_{1, MR} (e.g., each PRACH resource in the fourth set of PRACH resources is associated with a beam in the q_{1, MR}).

The BFR configuration may include the SS (e.g., the SS for the BFR) for receiving the confirmation indication for the new MR beam.

The WTRU may receive the first time offset and the second time offset (e.g., the first time offset is greater than the second time offset) associated with the PDCCH monitoring upon receiving a wake-up indication via the LP-WUS.

The WTRU may receive the one or more configurations and/or indications for starting to operate in the LP mode (e.g., monitor for the LP signals and the one or more LR beams etc.).

In an example, the WTRU may receive the indication and/or configuration (e.g., via one or more of the RRC signaling, the RRC release message, the DCI indication, and/or the MAC-CE indication etc.) for operating in the LP mode. The WTRU may receive the one or more LR beams to use for the LP signal monitoring while in the LP mode. The WTRU may start to operate in the LP mode (e.g., place the MR in the sleep state (e.g., the deep sleep state) and turn on the LR for the LP signal (e.g., the LP-WUS, the LP-SS) monitoring, start monitoring the LP signals (e.g., based on the configured LR beam) after a preconfigured (e.g., via one or more of the RRC signaling, the MAC-CE indication, and/or the DCI indication etc.) time. In an example, the WTRU may start to operate in the LP mode after a preconfigured (e.g., via one or more of the RRC signaling, the MAC-CE indication, and/or the DCI indication etc.) time offset from receiving the indication and/or configuration to operate in the LP mode.

The WTRU may detect the LR BFs and/or the MR BFs. To detect the LR BFs and/or the MR BFs, the WTRU may monitor the signal quality (e.g., the RSRP) of the q_{0, LR}, and/or the signal quality of the q_{0, MR}. In an example, based on the measured signal quality, the WTRU may detect the LR BF and/or the MR BF. In an example, the WTRU may detect the LR BF based on one or more of the following, for example, the WTRU may measure (e.g., periodically) the signal quality of the resources in the q_{0, LR}. If the measured signal quality (e.g., the RSRP) of the one or more (e.g., all) resources in the q_{0, LR} is less than a threshold associated with the signal quality for the q_{0, LR}, the WTRU may determine the LR BFI.

In an example, if the LR-BFD timer is not running, the WTRU may start the LR-BFD timer, start or restart LR-BFI counter (e.g., the set LR-BFI counter to zero), and increase the LR-BFI counter by the preconfigured step size (e.g., 1).

In an example, if the LR-BFD timer is running, the WTRU may increase the LR-BFI counter by the preconfigured (e.g., via one or more of the RRC signaling, the MAC-CE indication, and/or the DCI indication etc.) step size (e.g., 1) and the restart LR-BFD timer.

In an example, if the LR-BFI counter reaches and/or exceeds the threshold associated with the LR-BFI counter, the WTRU may determine the LR BF.

The WTRU may detect the MR BF based on one or more of the following, for example, the WTRU may measure (e.g., periodically) the signal quality of the resources in the q_{0, MR}. If the measured signal quality (e.g., the RSRP) of the one or more (e.g., all) resources in the q_{0, MR} is less than the threshold associated with the signal quality for the q_{0, MR}, the WTRU may determine the LR BFI. In an example, while operating in the LP mode, the WTRU may (e.g., periodically) wake-up the MR and measure the one or more MR resources in the q_{0, MR}.

In an example, if the MR-BFD timer is not running, the WTRU may start the MR-BFD timer, start and/or restart the MR-BFI counter (e.g., set the MR-BFI counter to zero), and increase the MR-BFI counter by a preconfigured (e.g., via one or more of the RRC signaling, the MAC-CE indication, and/or the DCI indication etc.) step size (e.g., 1).

In an example, if the MR-BFD timer is running, the WTRU may increase the MR-BFI counter by the preconfigured step size (e.g., 1) and restarts the MR-BFD timer.

In an example, if the MR-BFI counter reaches or exceeds the threshold MR-BFI counter value, the WTRU may determine the MR BF.

The WTRU may recover from the LR BF. In that, in an example, the WTRU may determine the LR BF while the MR radio link is still working (e.g., the WTRU determines the LR BF only). In an example, the WTRU may determine the LR BF based on the configuration (e.g., the LR-BFI counter, the LR-BFD timer, and/or the threshold LR-BFI counter value etc.). In one example, the WTRU may stop the LP signal monitoring upon detecting the LR BF and/or wake up the MR for monitoring the MR signals and/or channels (e.g., the PDCCH). In one example, the WTRU may determine that the MR link is working (e.g., the MR BF is not detected) by monitoring the MR link after detecting the LR BF. In an example, such determination for the MR BF may be based on the MR-BFD configuration (e.g., the MR-BFI counter, the MR-BFD timer, and/or the threshold MR-BFI counter value etc.) configured for the MR and may be performed upon detecting the LR BF or separately from the LR BF. In an example, such determination for the MR BF may be performed for a preconfigured time duration (e.g., in terms of the timer, and/or the BFI counter, and/or the BFI threshold number, and/or number (k) of the q_{0, MR} measurement instances) after detecting the LR BF and/or before initiating the beam failure recovery for the LR and/or may be initiated as soon as the LR BF has been detected and/or may be initiated as soon as the LR BF has been detected and the MR has been turned on etc.

In an example, upon detection of the LR BF, the WTRU may measure and determine the available (e.g., new) beams for the LR. In one example, the measurements and determination may be performed by the LR and/or the MR. In one example, the measurements are performed for a set of beams where the set may be configured by the network (e.g., the q_{1, LR}). In another option, multiple sets of such beams may be configured. In one example, the WTRU may determine zero, one or more available candidate beams from the set q_{1, LR} based on the measurements and determining. The availability of the zero, one or more beams may be determined based on first beam quality (e.g., based on the RSRP, the RSRQ, and/or the SINR etc.) threshold.

In one solution, the WTRU indicates the availability of zero, one or more LR candidate beams to the network. In one example, availability of zero, one or more candidate beams may be indicated by the MR signaling and may use, e.g., the PUCCH signaling (e.g., in a bitmap), the MAC-CE signaling, transmitting the PRACH preamble (e.g., a PRACH resource among the first set of PRACH resources) associated with at least one of zero, one (e.g., best candidate beam) or more candidate beams. In one example, if zero candidate beams are detected (i.e., no new beam meets the first beam quality threshold), the WTRU may exit the LP signal monitoring. In further examples, the WTRU may indicate via the MR signaling that the WTRU exits the LP signal monitoring. In such case, the WTRU may operate based on the MR DRX configuration and/or monitor for the PDCCHs based on the LP-WUS cycle for the preconfigured duration and/or until acknowledgement is received from the gNB for the indication of exiting the LP signal monitoring. After exiting the LP signal monitoring, the WTRU may continue to monitor for the MR BFs based on the MR-BFD configuration.

In one solution, the WTRU may receive the new LR beam for the LP signal monitoring from the network and/or the gNB. In one example, based on receiving the new LR beam for the LP signal monitoring, the WTRU may determine that the BFR for the LR link is successful. In an example, based on determining that the BFR for the LR link is successful, the WTRU may set the LR-BFI counter to zero. In one example, the WTRU may receive indication for the new LR beam via the one or more of the RRC signaling (e.g., the RRC reconfiguration message), the MAC (e.g., the MAC CE) or the PHY (e.g., the DCI) layer signaling. In one example, upon receiving the new LR beam for the LP signal monitoring, the WTRU may resume the LP signal monitoring based on the new beam after the preconfigured (e.g., via the one or more of RRC signaling, the MAC-CE indication, and/or the DCI indication etc.) time. In one example, if the WTRU (e.g., through the MR) does not receive the new LR beam for the LP signal monitoring within the preconfigured (e.g., via one or more of the RRC signaling, the MAC-CE indication, and/or the DCI indication etc.) time, the WTRU may continue to operate based on the MR signal monitoring.

In an embodiment, the WTRU may recovering from the MR BF.

The WTRU may determine that the radio link associated with the MR is in the BF while the radio link associated with the LR is working (hereafter, referred to as the MR BF only state). In an example, the WTRU may determine the MR BF and continue to monitor for the LR BF for the preconfigured (e.g., via the RRC signaling the MAC-CE indication and/or the DCI indication etc.) duration (e.g., a number of (e.g., periodic) measurements instances associated with the q_{0, LR}). If the WTRU does not detect the LR BF within the preconfigured duration, the WTRU may determine that the WTRU is in the MR BF only state. While the WTRU is in the MR BF only state, the WTRU may monitor for the LR BF based on the LR-BFD configuration. The WTRU in the MR BF only state may perform the BFR and the LP signal monitoring based on one or more of the following, for example, upon detecting the MR BF only state, the WTRU may determine to monitor the LP signals while the MR is placed in the sleep (e.g., the deep sleep) or the inactive state (hereafter also referred to as the WTRU operating in the LP mode with inactive MR). In an example, the WTRU may monitor for the LP-WUS and/or the LP-SS via the LR and suspend one or more operations associated with the MR (e.g., transmitting one or more CSI reports, transmitting one or more SRSs, monitoring for the MR BFD etc.) and postpone recovering from the detected MR BF.

In an example, the determination, by the WTRU, to operate in the LP mode with inactive MR may be based on the signal quality associated with the LR. In an example, if the signal quality (e.g., the RSRP) associated with the one or more (e.g., all) resources in the q_{0, LR} is greater than a preconfigured (e.g., via one or more of the RRC signaling, the MAC-CE indication, and/or the DCI indication etc.) threshold, the WTRU may determine to operate in the LP mode with inactive MR.

In an example, the determination, by the WTRU, to operate in the LP mode with inactive MR may be based on a mobility of the WTRU. In an example, if speed of the WTRU is less than or equal to a preconfigured (e.g., via the RRC signaling, the MAC-CE indication, the DCI indication) threshold, the WTRU may determine to operate in the LP mode with inactive MR.

In an example, if the measured (e.g. based on the one or more preconfigured RSs) doppler shift is less than or equal to a preconfigured (e.g., via the RRC signaling, the MAC-CE indication, and/or the DCI indication etc.) threshold, the WTRU may determine to operate in the LP mode with inactive MR.

In an example, the determination, by the WTRU, to operate in the LP mode with inactive MR may be based on the gNB indication and/or configuration (e.g., via one or more of the RRC signaling, the MAC-CE indication, and/or the DCI indication etc.). In an example, the WTRU may be configured to operate in the LP mode with inactive MR upon detection that the WTRU is in the MR BF only state.

If the WTRU receives an indication via the LP-WUS to wake-up (e.g., for monitoring the PDCCHs) while operating in the LP mode with inactive MR, the WTRU may indicate the gNB that the WTRU was in the LP mode with inactive MR, determine the new MR beam, and indicate the selected new MR beam to the gNB. The WTRU may determine the new MR beam. In an example, upon receiving the indication via the LP-WUS to wake-up (e.g., for the PDCCH monitoring), the WTRU may wake-up and/or activate the MR and measure the quality (e.g., the RSRP) of beams in the q_{1, MR}. If at least one beam among the q_{1, MR} meets the second beam quality threshold, the WTRU may select a (e.g., beast beam in terms of the signal quality) beam among the q_{1, MR} meeting the second beam quality threshold as the new MR beam. If none of the beams among the q_{1, MR} meets the second beam quality threshold, the WTRU may perform the initial access for reconnecting to the network.

The WTRU may indicate determined the new MR beam and that the WTRU was in the LP mode with inactive MR to the gNB. In an example, the WTRU may transmit the PRACH resource associated with the selected new MR beam among the second set of PRACH resources.

The WTRU may monitor for and/or receive the PDCCH based on the new MR beam at least after the first time offset. In an example, the WTRU may start a timer associated with the PDCCH monitoring after the first time offset from the reception of the LP-WUS (e.g., last symbol of the LP-WUS). The WTRU may receive the one or more signals (e.g., the SSB, the CSI-RSs etc.) and/or the channels (e.g., the PDSCH) and/or transmits the one or more signals (e.g., the SRS) and/or channels (e.g., the PUCCH, the PUSCH etc.), based on scheduling received via the received PDCCH.

In an example, upon detecting the MR BF only state, the WTRU may determine (e.g., based on the LR link quality is less than a preconfigured threshold and/or the mobility is greater than a preconfigured threshold, and/or based on the gNB indication and/or configuration etc.) not to operate in the LP mode with inactive MR. The WTRU that determines not to operate in the LP mode with inactive MR may determine the new beam for the MR. After determining the new MR beam, the WTRU may resume the LP-WUS monitoring. If the WTRU receives the wake-up indication (e.g., via the LP-WUS), the WTRU may perform the PDCCH monitoring at least after the second time offset. In an example, the WTRU may measure the signal quality (e.g., the RSRP) of beams in the q_{1, MR}. If at least one beam among the q_{1, MR} meets the second beam quality threshold, the WTRU may determine a (e.g., the beast beam in terms of the signal quality) beam among the q_{1, MR} meeting the second beam quality threshold as the new MR beam. If the WTRU determines none of beams among the q_{1, MR} meets the second beam quality threshold, the WTRU may perform the initial access to reconnect to the network.

In an example, the WTRU may indicate the determined new MR beam and that the WTRU is not operating in the LP mode with inactive MR to the gNB. In an example, the WTRU may transmit the PRACH resource associated with the selected new MR beam among the third set of PRACH resources. Upon indicating the selected new MR beam, the WTRU may monitor for and/or receive the confirmation for the new MR beam from the gNB. In an example, the WTRU may monitor for and/or receive the PDCCH in the BFR SS within the preconfigured (e.g., via one or more of the RRC signaling, the MAC-CE indication, and/or the DCI indication) time window.

In an example, the WTRU that determines the new beam for the MR may resume the LP signal monitoring and perform the one more operations associated with the MR (e.g., transmitting one or more CSI reports, transmitting the SRSs, monitoring for the MR BFD via the MR-BFD RSs determined based on the new beam for the MR).

In an example, if the WTRU receives the wake-up indication (e.g., for the PDCCH monitoring) via the LP-WUS, the WTRU may wake-up and/or activate the MR and monitor for and/or receive the PDCCH based on the new MR beam at least after the second time offset. In an example, the WTRU may start the timer associated with the PDCCH monitoring after the second time offset from receiving the LP-WUS (e.g., last symbol of the LP-WUS). The WTRU may receive the one or more signals (e.g., the SSB, the CSI-RSs etc.) and/or channels (e.g., the PDSCH) and/or transmit the one or more signals (e.g., the SRS) and/or the channels (e.g., the PUCCH, the PUSCH etc.), based on the scheduling received via the PDCCH.

The WTRU may recover from both the LR BF and the MR BF. The WTRU may determine that the radio links associated with the MR and the LR are in the BFs (hereafter also referred to as the WTRU is in the MR and the LR BFs state).

In a first example, the WTRU may determine the MR BF and monitor for the LR BF for the preconfigured (e.g., via the RRC signaling, the MAC-CE indication, and/or the DCI indication etc.) duration (e.g., the number of (e.g., periodic) measurements instances associated with the q_{0, LR}). If the WTRU detects the LR BF within the preconfigured duration, the WTRU may determine that the WTRU is in the MR and LR BFs state. If the WTRU does not detect the LR BF within the preconfigured duration, the WTRU may determine that the WTRU is not in the MR and LR BFs state.

In a second example, the WTRU may determine the LR BF and monitor for the MR BF for the preconfigured (e.g., via the RRC signaling, the MAC-CE indication, and/or the DCI indication) duration (e.g., a number of (e.g., periodic) measurements instances associated with the q_{0, MR}). If the WTRU detects the MR BF within the preconfigured duration, the WTRU may determine that the WTRU is in the MR and LR BFs state. If the WTRU does not detect the MR BF within the preconfigured duration, the WTRU may determine that the WTRU is not in the MR and LR BFs state.

The WTRU in the MR and LR BFs state may perform the BFR and the LP signal monitoring based on one or more of following, for example, the WTRU may indicate to the gNB that the WTRU is in the MR and LR BFs state and determine a new beam for MR. Upon determining the new MR beam and recovering from the MR BF, the WTRU may report the available beams for the LR. In that, the WTRU may measure the signal quality (e.g., the RSRP) of the beams in the q_{1, MR}. If at least one beam among the q_{1, MR} meets the second beam quality threshold, the WTRU may determine a (e.g., beast beam in terms of the signal quality) beam among the q_{1, MR} meeting the second beam quality threshold as the new MR beam.

The WTRU may indicate the determined new MR beam and that the WTRU is in the MR and LR BFs state to the gNB. In an example, the WTRU may transmit the PRACH resource associated with the selected new MR beam among the fourth set of PRACH resources. Upon indicating the selected new MR beam, the WTRU may monitor for and/or receive the confirmation for the new MR beam from the gNB. In an example, the WTRU may monitor for and/or receive the PDCCH in the BFR SS within the preconfigured (e.g., via the one or more of the RRC signaling, the MAC-CE indication, and/or the DCI indication etc.) time window. Upon receiving confirmation for the new MR beam, the WTRU may operate based on the DRX configuration using the new MR beam (e.g., monitor for and/or receive the PDCCHs based on the new MR beam in the resources (e.g., the DRX on duration) configured for the PDCCH monitoring by the DRX configuration). Alternatively, upon receiving confirmation for the new MR beam, the WTRU may operate based on the LP-WUS cycle (e.g., monitor for and/or receive the PDCCHs based on the new MR beam in the PDCCH monitoring resources configured by the LP-WUS configuration). If none of beams among the q_{1, MR} meets the second beam quality threshold, the WTRU may perform initial access to reconnect to the network.

The WTRU may measure the beam quality (e.g., the RSRP) of the resources in the q_{1, LR} and determine the available (resources in the q_{1, LR} meeting the first beam quality threshold) LR candidate beams. After the WTRU recovers from the MR BF, the WTRU may report (e.g., in a bitmap transmitted, the available LR candidate beams to the gNB (e.g., via preconfigured (e.g., via one or more of the RRC signaling, the MAC-CE indication, and/or the DCI indication etc.) UL resources (e.g., the PUCCH, the PUSCH etc.)).

In an embodiment, a method performed by the WTRU for detecting the MR BFs based on the one or more LR measurements is provided. The WTRU detects the potential MR BFs based on the LR measurements. The WTRU that detects the potential MR BF, measures the MR BFD-RSs to evaluate the detected potential MR BFs. If the potential MR BFs are determined to be the MR BF, the WTRU may perform the BFR via the MR.

The WTRU receives the BFD configuration (i.e. the LR-BFD configuration) associated with the LR which includes one or more of the set of LR resources (e.g., the LP-SSs) for the BFD (i.e. the q_{0, LR}), the quality threshold for the q_{0, LR}, the LR BFI counter and associated threshold, and/or the timer (LR-BFD timer) associated with the LR-BFI counter etc.

The WTRU receives the MR-BFD configuration including one or more of: the set of MR RSs for the BFD (i.e. the q_{0, MR}), the quality threshold for the q_{0, MR}, the MR-BFI counter and the associated threshold, the timer (MR-BFD timer) associated with the MR-BFI counter.

In an example, the first and second MR-BFD configurations share configurations and/or parameters except the MR-BFI counters and the respective thresholds (e.g., the first and second MR-BFD configurations are associated with the first MR-BFI counter and the first counter threshold, and the second MR-BFI counter and the second counter threshold (e.g., greater than the first counter threshold) respectively).]

In an example, the WTRU receives the BFR configuration which includes one or more of the set of candidate beams for the LR (i.e. the q_{1, LR}) and the MR (the q_{1, MR}), the association between the q_{1, MR} and the q_{1, LR} (e.g., the one or more beams in the q_{1, MR} associated with each beam in the q_{1, LR}), the first and second beam quality thresholds, the first and second sets of the PRACHs resources associated with (e.g., each) beam in the q_{1, MR}, the search space (BFR SS), and/or the sequence associated with the LP-WUS etc.

The WTRU receives the LR beam and configurations and/or indications for starting to monitor for the LP-WUS.

The WTRU receives the one or more BFD configurations (e.g., the first and second MR-BFD configurations) associated with the MR.

The WTRU starts monitoring for the LP-WUS based on the configured LR beam.

The WTRU monitors for the potential MR BF based on the signal quality (e.g., the RSRP) measurements on the q_{0, LR} via the LR. In an example, if the quality (e.g., the RSRP) of the one or more (e.g., all) beams in the q_{0,LR} is less than the signal quality threshold for the q_{0, LR}, the WTRU determines the LR BFI. If the LR-BFD timer is not running (e.g., expires), the WTRU starts or restarts the LR-BFI counter (set to 0), increases the LR-BFI counter by 1, and restarts the LR-BFD timer. If the LR-BFD timer is running, the WTRU increases the LR-BFI counter by 1, and restarts the LR-BFD timer. If the LR-BFI counter exceeds or equals the configured threshold, the WTRU determines the potential MR BF.

The WTRU evaluates the determined potential MR BF based on the MR measurements and the first MR-BFD configuration. In an example, the WTRU (e.g., periodically) measures the signal quality (e.g., the RSRP) of the q_{0,MR}. If the quality of the one or more (e.g., all) beams in the q_{0,MR} is less than the signal quality threshold for the one or more MR resources in the q_{0, MR}, the WTRU determines the MR BFI. If the MR-BFD timer is not running, the WTRU starts or restarts the first MR-BFI counter (set to zero), increases the MR-BFI counter by 1, and restarts the MR-BFD timer. If the MR-BFD timer is running, the WTRU increases the first MR-BFI counter by 1, and restarts the LR-BFD timer. If the first MR-BFI counter exceeds or equals the configured threshold within the time window (e.g., the time window from starting to monitor the q_{0,MR}), the WTRU determines the potential MR BF is the MR BF.

If the WTRU determines the potential MR BF is the MR BF, the WTRU measures the quality of the q_{1,MR} and q_{1, LR}. The WTRU selects the one or more new beams for the MR (i.e. the q_{new, MR}) and/or the LR (the q_{new, LR}) based on the measurements. The WTRU indicates the one or more selected new beams to the gNB and receives the confirmation for the selected new beams from the gNB via the LP-WUS or the DCI received via the BFR SS

In an example, if at least one beam pair meets the quality thresholds (the quality of a beam among the q_{1, MR} is greater than or equal to the first beam quality threshold, and the quality of the beam in the q_{1, LR} associated with the selected beam among the q_{1, MR} is greater than or equal to the second beam quality threshold), the WTRU selects the (e.g., best) new beam pair (the q_{new, MR} and the q_{new, LR} etc.).

In an example, the WTRU transmits the PRACH resource among the first set of PRACH resources associated with the q_{new, MR}. The WTRU receives the confirmation from the gNB for the selected new beam pair via the LP-WUS (e.g., the LP-WUS associated with the preconfigured sequence). The WTRU continues monitoring the LP-WUS based on the determined new LR beam (i.e. the q_{new, MR}).

In an example, if none of the candidate beam pairs meets the respective thresholds, but quality of at least one beam in the q_{1, MR} is greater than or equal to the first beam quality threshold, the WTRU selects a (e.g., best) beam among the q_{1, MR} meeting the first beam quality threshold as the q_{new, MR}.

In an example, the WTRU transmits the PRACH resource among the second set of PRACH resources which are associated with the q_{new, MR}. The WTRU receives the confirmation for the q_{new, MR} via the BFR SS. The WTRU operates based on the DRX configuration with the q_{new, MR}, and performs the BFD for the MR based on the second MR-BFD configuration.

In an example, if the WTRU determines the quality of all beams in the q_{1, MR} is less than the first threshold, the WTRU performs the initial access.

In an example, if the WTRU determines the potential MR BF is not the MR BF, the WTRU determines the LR BF. The WTRU exits the LP signal monitoring (e.g., the WTRU operates based on the DRX configuration etc.) and transmits the indication (e.g., via the PUCCH) to the gNB. Upon exiting the LP signal monitoring, the WTRU performs the BFD for the MR based on second MR-BFD configuration.

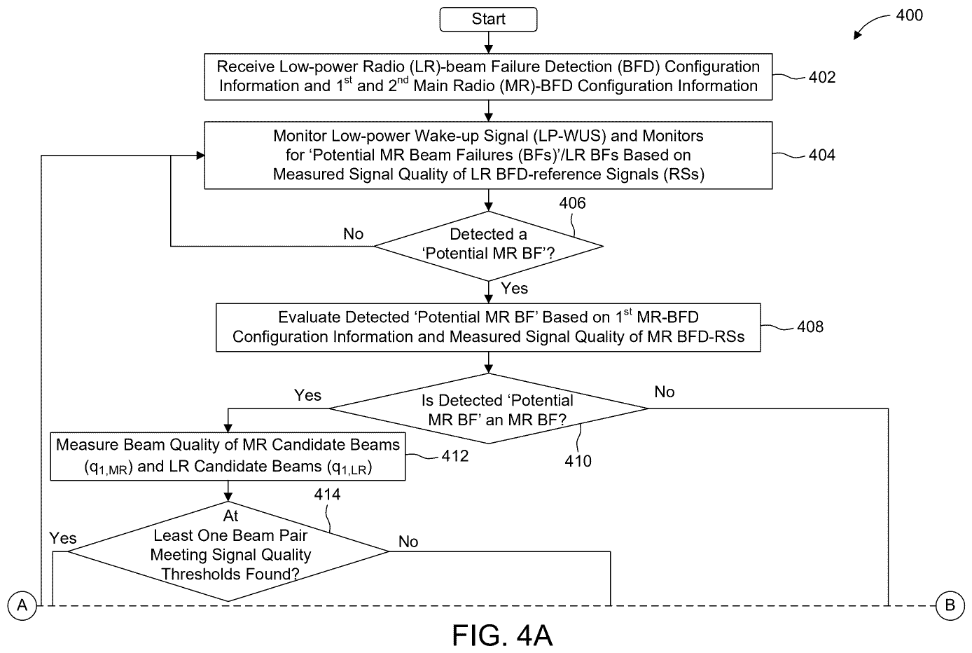

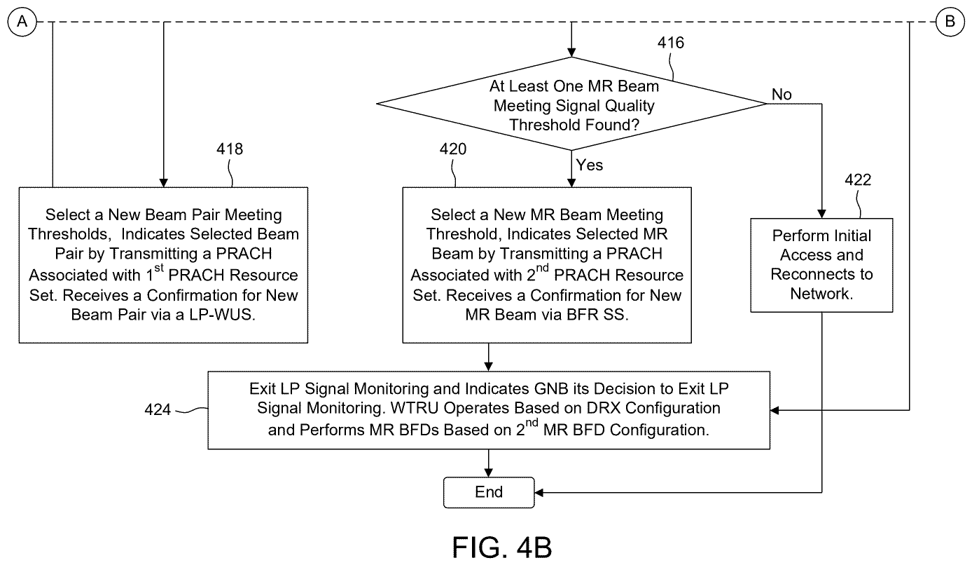

Referring now to FIGS. 4A-4B, a flowchart 400 illustrating a method for beam failure recovery for devices monitoring low-power signals is shown according to one or more embodiments. The method may be performed by the WTRU.

At 402, the WTRU receives the LR-BFD configuration information, the first MR-BFD configuration information, and the second MR-BFD configuration information.

At 404, the WTRU monitors the LP signal (e.g., the LP-WUS) and monitors for the potential MR BFs and/or LR BFs based on a measured signal quality of the LR BFD RSs.

At 406, the WTRU checks if the potential MR BF is determined.

If, at 406, the WTRU does not determine the potential MR BF, the WTRU continues monitoring the LP signal (e.g., the LP-WUS).

If, at 406, the WTRU determines the potential MR BF, then at 408, the WTRU evaluates the detected potential MR BF based on the first MR-BFD configuration information and the measured signal quality of MR BFD RSs.

At 410, the WTRU checks if the detected potential MR BF is an MR BF.

If, at 410, the WTRU determines that the potential MR BF is an MR BF, then at 412, the WTRU measures the beam quality of MR candidate beams (q_{1,MR}) and LR candidate beams (q_{1,LR}).

At 414, the WTRU checks whether at least one candidate beam pair meeting the one or more signal quality thresholds is found.

If, at 414, the WTRU determines that no candidate beam pair meets the one or more signal quality thresholds, then at 416, the WTRU checks if at least one MR beam meeting the MR signal quality threshold is found.

If, at 414, the WTRU determines at least one candidate beam pair meeting the one or more signal quality thresholds, then at 418, the WTRU selects a new beam pair meeting the one or more signal quality thresholds, indicates the selected beam pair by transmitting the PRACH associated with the first set of PRACH resources. The WTRU receives the confirmation for the new beam pair via the LP-WUS. Thereafter, the WTRU continues monitoring the LP signal (e.g., the LP-WUS).

If, at 416, the WTRU finds the at least one MR beam meeting the MR signal quality threshold, then at 420, the WTRU selects the new MR beam meeting the MR signal quality threshold, indicates the selected MR beam by transmitting the PRACH associated with the second set of PRACH resources. The WTRU receives the confirmation for the new MR beam via the BFR SS. Thereafter, at 424, the WTRU exits the LP signal monitoring and indicates the gNB about the decision to exit the LP signal monitoring. The WTRU operates based on the DRX configuration and performs the MR BFDs based on the second MR BFD configuration information.

If, at 416, the WTRU does not find any MR beam meeting the MR signal quality threshold, at 422, the WTRU performs the initial access and reconnects to the network.

If, at 410, the WTRU does not detect the potential MR BF, then at 424, the WTRU exits the LP signal monitoring and indicates the gNB about the decision to exit the LP signal monitoring. The WTRU operates based on the DRX configuration and performs the MR BFDs based on the second MR BFD configuration information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer. A “timer” may refer to any device, system, or mechanism, whether hardware, software, or a combination thereof, designed to measure, track, or regulate the passage of time. This includes, but is not limited to: clock-based timers, count-down timers, count-up timers, interval timers, event based timers, multifunction timers, and any other mechanism for measuring a duration of time.

What is claimed is:

1. A wireless transmit/receive unit (WTRU), comprising:
a memory;
a low power radio (LR);
a main radio (MR);
a transceiver configured to:
receive, from a base station, first configuration information indicating one or more of: one or more LR resources, an LR signal quality threshold, an LR beam failure instance (LR-BFI) counter threshold, or an LR beam failure detection (LR-BFD) timer value; and
a processor, wherein the transceiver and the processor are configured to:
monitor a low power (LP) signal,
measure an LR signal quality of the one or more LR resources,
determine an LR BFI when the LR signal quality is less than the LR signal quality threshold,
initialize an LR-BFD timer using the LR-BFD timer value,
increment an LR-BFI counter upon detecting the LR-BFI, and
determine a potential MR beam failure when the LR-BFI counter exceeds the LR-BFI counter threshold and the LR-BFD timer has not expired.

2. The WTRU of claim 1, wherein the transceiver and the processor are further configured to:
receive, from the base station, second configuration information indicating one or more of: one or more MR resources, an MR signal quality threshold, an MR beam failure instance (MR-BFI) counter threshold, or an MR beam failure detection (MR-BFD) timer value, and
evaluate the potential MR beam failure based on the second configuration information.

3. The WTRU of claim 2, wherein evaluating the potential MR beam failure comprises:
resetting the LR-BFD timer and the LR-BFI counter,
activating the MR,
initializing an MR-BFD timer using the MR-BFD timer value,
measuring an MR signal quality of the one or more MR resources,
determining an MR-BFI when the MR signal quality is less than the MR signal quality threshold, and
incrementing an MR-BFI counter upon determining the MR-BFI.

4. The WTRU of claim 3, wherein the transceiver and the processor are further configured to:
determine an MR beam failure when the MR-BFI counter exceeds the MR-BFI counter threshold within a time window.

5. The WTRU of claim 4, wherein the transceiver and the processor are further configured to:
receive third configuration information indicating one or more of: one or more candidate LR beams, one or more candidate MR beams, an association between the one or more candidate LR beams and the one or more candidate MR beams, a first set of physical random-access channel (PRACH) resources, a second set of PRACH resources, an LR beam quality threshold, or an MR beam quality threshold.

6. The WTRU of claim 5, wherein the transceiver and the processor are further configured to:
determine that at least one LR beam from the one or more candidate LR beams meets the LR beam quality threshold,
determine that at least one MR beam associated with the at least one LR beam meets the MR beam quality threshold,
select the at least one LR beam and the at least one MR beam, and
transmit, to the base station using the first set of PRACH resources, an indication of selecting the at least one LR beam and the at least one MR beam.

7. The WTRU of claim 5, wherein the transceiver and the processor are further configured to:
determine that at least one MR beam from the one or more candidate MR beams meets the MR beam quality threshold,
determine that no LR beam from the one or more candidate LR beams meets the beam quality threshold,
operate in a discontinuous reception (DRX) mode using the at least one MR beam, and
transmit, to the base station using the second set of PRACH resources, an indication of the DRX mode using the at least one MR beam.

8. The WTRU of claim 3, wherein the transceiver and the processor are further configured to:
exit the LP signal monitoring when the MR-BFI counter does not exceed the MR-BFI counter threshold within a time window, and
transmit an indication to the base station upon exiting the LP signal monitoring.

9. The WTRU of claim 8, wherein the transceiver and the processor are further configured to:
receive fourth configuration information, and
evaluate the MR beam failure based on the fourth configuration information when operating in a DRX mode.

10. The WTRU of claim 1, wherein the MR is inactive while monitoring the LP signal.

11. A method for use in a wireless transmit/receive unit (WTRU), the method comprising:
receiving, from a base station, first configuration information indicating one or more of: one or more low power radio (LR) resources, an LR signal quality threshold, an LR beam failure instance (LR-BFI) counter threshold, or an LR beam failure detection (LR-BFD) timer value;
monitoring a low power (LP) signal using a low power radio receiver;
measuring an LR signal quality of the one or more LR resources;
determining an LR BFI when the LR signal quality is less than the LR signal quality threshold;
initializing an LR-BFD timer using the LR-BFD timer value;
incrementing an LR-BFI counter upon detecting the LR-BFI; and
determining a potential main radio (MR) beam failure when the LR-BFI counter exceeds the LR-BFI counter threshold and the LR-BFD timer has not expired.

12. The method of claim 11, the method further comprising:
receiving, from the base station, second configuration information indicating one or more of: one or more MR resources, an MR signal quality threshold, an MR beam failure instance (MR-BFI) counter threshold, or an MR beam failure detection (MR-BFD) timer value; and
evaluating the potential MR beam failure based on the second configuration information.

13. The method of claim 12, wherein evaluating the potential MR beam failure comprises:
resetting the LR-BFD timer and the LR-BFI counter;
activating the MR;
initializing an MR-BFD timer using the MR-BFD timer value;
measuring an MR signal quality of the one or more MR resources;
determining an MR-BFI when the MR signal quality is less than the MR signal quality threshold; and
incrementing an MR-BFI counter upon determining the MR-BFI.

14. The method of claim 13, the method further comprising:
determining an MR beam failure when the MR-BFI counter exceeds the MR-BFI counter threshold within a time window.

15. The method of claim 13, the method further comprising:
receiving third configuration information indicating one or more of: one or more candidate LR beams, one or more candidate MR beams, an association between the one or more candidate LR beams and the one or more candidate MR beams, a first set of physical random-access channel (PRACH) resources, a second set of PRACH resources, an LR beam quality threshold, or an MR beam quality threshold.

16. The method of claim 15, the method further comprising:
determining that at least one LR beam from the one or more candidate LR beams meets the LR beam quality threshold;
determining that at least one MR beam associated with the at least one LR beam meets the MR beam quality threshold;
selecting the at least one LR beam and the at least one MR beam; and
transmitting, to the base station using the first set of PRACH resources, an indication of selecting the at least one LR beam and the at least one MR beam.

17. The method of claim 15, the method further comprising:
determining that at least one MR beam from the one or more candidate MR beams meets the MR beam quality threshold;
determining that no LR beam from the one or more candidate LR beams meets the beam quality threshold;
operating in a discontinuous reception (DRX) mode using the at least one MR beam; and
transmitting, to the base station using the second set of PRACH resources, an indication of the DRX mode using the at least one MR beam.

18. The method of claim 13, the method further comprising:
exiting the LP signal monitoring when the MR-BFI counter does not exceed the MR-BFI counter threshold within a time window; and
transmitting an indication to the base station upon exiting the LP signal monitoring.

19. The method of claim 18, the method further comprising:
receiving fourth configuration information; and
evaluating the MR beam failure based on the fourth configuration information when operating in a DRX mode.

20. The method of claim 11, wherein a main radio receiver is inactive while monitoring the LP signal.
